(19) United States
(12) Patent Application Publication
(10) Pub. No.: US 2016/0218659 A1
(43) Pub. Date: Jul. 28, 2016

(54) PILE, PILE INSTALLATION JIG, METHOD FOR INSTALLING THE PILE, AND PHOTOVOLTAIC SYSTEM USING THE PILES

(71) Applicant: SHARP KABUSHIKI KAISHA, Osaka-shi, Osaka (JP)

(72) Inventors: Kengo MATSUYAMA, Osaka-shi, Osaka (JP); Kenta NAKAMURA, Osaka-shi, Osaka (JP)

(21) Appl. No.: 14/917,392

(22) PCT Filed: Aug. 21, 2014
(86) PCT No.: PCT/JP2014/071826

§ 371 Date: Mar. 8, 2016

(30) Foreign Application Priority Data
Sep. 9, 2013 (JP) 2013-186304

(51) Int. Cl. H02S 20/10; E02D 13/00; E02D 7/02; E02D 5/54

(52) U.S. Cl. CPC H02S 20/10; E02D 5/54; E02D 13/00; E02D 7/02

(57) ABSTRACT

When a pile installation jig (41) is driven deeper by the length of grooves (15a), (15b) in a pile main body (12), abutment edges (42a) of notches (42) in arms (41d), (41e) push a plate-like member (13) and cause displacement of the plate-like member (13) along the grooves (15a), (15b). Thereby, the plate-like member (13) is held at portions in the grooves (15a), (15b) where the grooves (15a), (15b) extend in a direction transverse to a longitudinal direction of the pile main body (12).

### TECHNICAL FIELD

The present invention relates to a pile to be driven into the ground, a pile installation jig, a method for installing the pile, and a photovoltaic system using the piles.

### BACKGROUND ART

The supporting capacity of a pile depends heavily on the type of the ground and the strata composition. Soft ground and weak strata seriously deteriorate the supporting capacity of the pile. In this regard, Patent Literature 1 discloses an attempt to improve the supporting capacity of a pile. First, a pipe and a main shaft inserted therein are driven into the ground. Then, only the pipe is driven further. When underground insertion parts at a leading end of the pipe abut on an inclined portion at a leading end of the main shaft, the underground insertion parts are bent and stuck obliquely downward in the ground.

Patent Literature 2 also discloses an attempt to improve the supporting capacity of a foundation pile. In this case, a foundation pile is driven into the ground first. Next, projecting members are inserted in a vertical space inside the foundation pile and pushed down until their leading ends project from projection holes formed in a side wall of the foundation pile. Thereby, the leading ends of the projecting members are stuck obliquely downward in the ground.

Patent Literature 3 tries to improve the supporting capacity of an anchor by driving an anchor into a supporting foundation, fitting a wedge splitting pipe in the anchor, hitting the wedge splitting pipe, and thereby opening a split wedge at a leading end of the anchor.

Patent Literature 4 also discloses an attempt to improve the supporting capacity of a pile main body. In this case, a pile main body has a pointed member at a leading end thereof and pivotally holds a pair of anti-falloff members at the leading end. When the pile main body is driven into the ground, the pointed member is displaced to open the anti-falloff members in the ground.

Patent Literature 5 tries to improve the supporting capacity of a pile main body in the following manner. When a pile main body is driven into the ground, a pressing member causes flared members on a leading end of the pile main body to be displaced and stuck in the ground.

Patent Literature 6 tries to improve the supporting capacity of a pile in the following manner. When a pile is driven into the ground, a pillar-shaped member causes flared members on a leading end of the pile to be displaced outwardly and stuck in the ground.

### PRIOR ART DOCUMENTS

### Patent Literature

[Patent Literature 1] JP H02-24416 A

[Patent Literature 2] JP H11-81306 A

[Patent Literature 3] JP H09-31979 A

[Patent Literature 4] JP H10-131180 A

[Patent Literature 5] JP 2005-9295 A

[Patent Literature 6] JP 2005-61159 A

### DISCLOSURE OF THE INVENTION

### Problems to be Solved by the Invention

In Patent Literature 1, the underground insertion parts at the leading end of the pipe, which are stuck obliquely downward in the ground, tend to come off easily. For this reason, this arrangement cannot ensure a significant improvement in the pullout strength of the pipe.

Patent Literature 2 requires a space for guiding the protrusion members inside the foundation pile, which complicates the structure of the foundation pile. Besides, the leading ends of the protrusion members, which are stuck obliquely downward in the ground, tend to come off easily. For this reason, this arrangement cannot ensure a significant improvement in the pullout strength of the foundation pile.

In Patent Literature 3, the anchor is driven into the supporting foundation to open the split wedge at the leading end of the anchor. However, if this structure is applied to a pile driven into the ground, the wedge pushes back sand and dirt around the pile and deteriorates the supporting capacity of the pile.

In Patent Literature 4, an end of each of the anti-falloff members is pivotally held on the pile main body. In this structure, the rigidity and the strength between the anti-falloff members and the pile main body are too low to expect a significant improvement in the supporting capacity of the pile main body.

In Patent Literature 5 and 6, in the state where a plurality of flared members are stuck in the ground, an end of each flared member is held only on the pile main body. In this structure, the rigidity and the strength between the flared members and the pile main body are too low to expect a significant improvement in the supporting capacity of the pile main body.

Additionally, Patent Literature 4 to 6 require complicated structures for the leading end of the foundation pile or the pile main body, and also require a greater number of components.

The present invention has been made in view of these conventional problems, and aims to provide a pile, a pile installation jig, a method for installing the pile, and a photovoltaic system using the piles, in which the pile has a simple structure but still ensures a high pullout strength and a high supporting capacity for a pile main body.

### Means for Solving the Problems

In order to solve the above-mentioned problems, a pile according to the present invention, which is a pile to be buried in the ground, is equipped with: a pile main body composed of a columnar member and including at least one groove which extends in a longitudinal direction of the columnar member and which curves in a direction transverse to the longitudinal direction; and a plate-like member which penetrates the groove.

A pile installation jig, which can be employed to install the pile according the present invention, is equipped with: an elongated portion arranged in a longitudinal direction of the pile main body; and an abutment portion provided closer to an end of the elongated portion than to a center thereof and configured to push the plate-like member.

A method according to the present invention for installing a pile includes the steps of: driving a pile into the ground, wherein the pile includes a pile main body and a plate-like member, the pile main body is composed of a columnar member and includes at least one groove which extends in a longitudinal direction of the columnar member and which curves in a direction transverse to the longitudinal direction, and the plate-like member penetrates the groove; and driving a pile installation jig into the ground to cause displacement of the plate-like member along the groove.

Alternatively, a method according to the present invention for installing a pile includes the steps of: driving a pile and a pile installation jig together into the ground, wherein the pile includes a pile main body and a plate-like member, the pile main body is composed of a columnar member and includes at least one groove which extends in a longitudinal direction of the columnar member and which curves in a direction transverse to the longitudinal direction, and the plate-like member penetrates the groove; and driving the pile installation jig further into the ground to cause displacement of the plate-like member along the groove.

A photovoltaic system according to the present invention is equipped with a rack assembled on a plurality of piles according to the present invention, and a photovoltaic module held on the rack.

### Effects of the Invention

The present invention can improve the pullout strength and the supporting capacity of a pile by a simple structure.

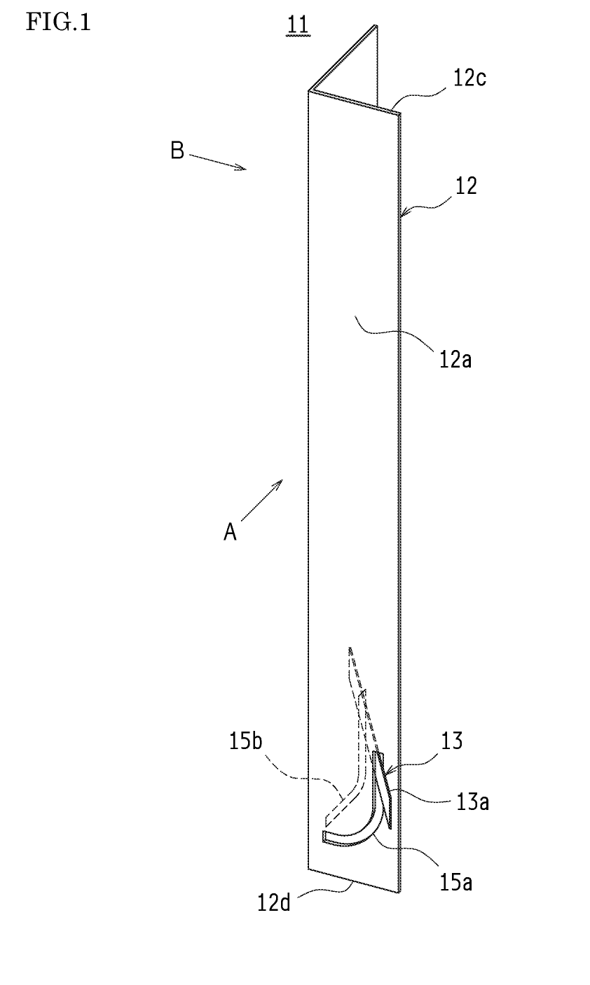

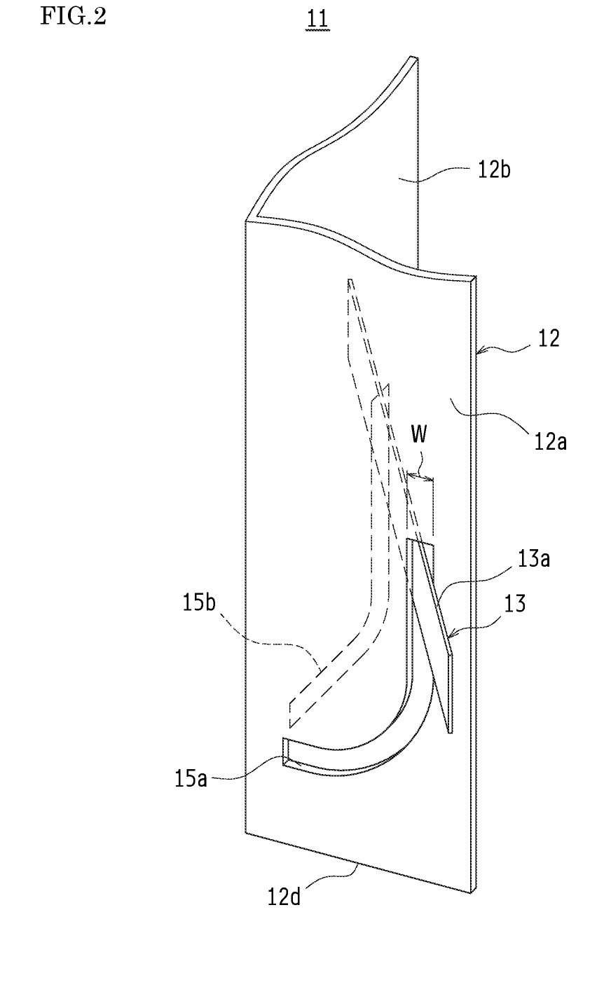

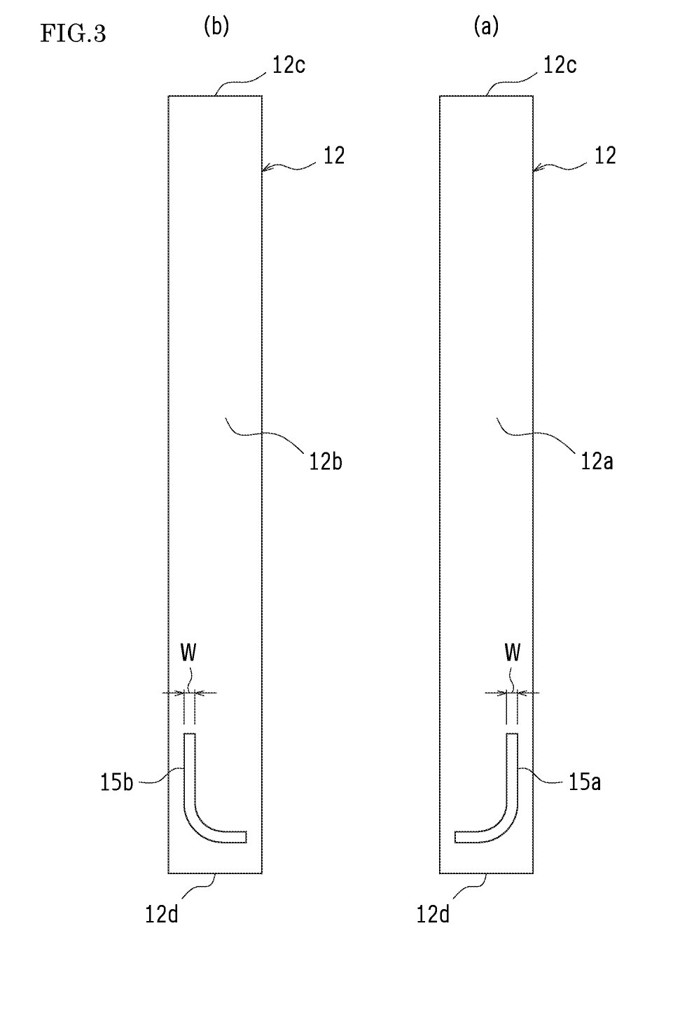

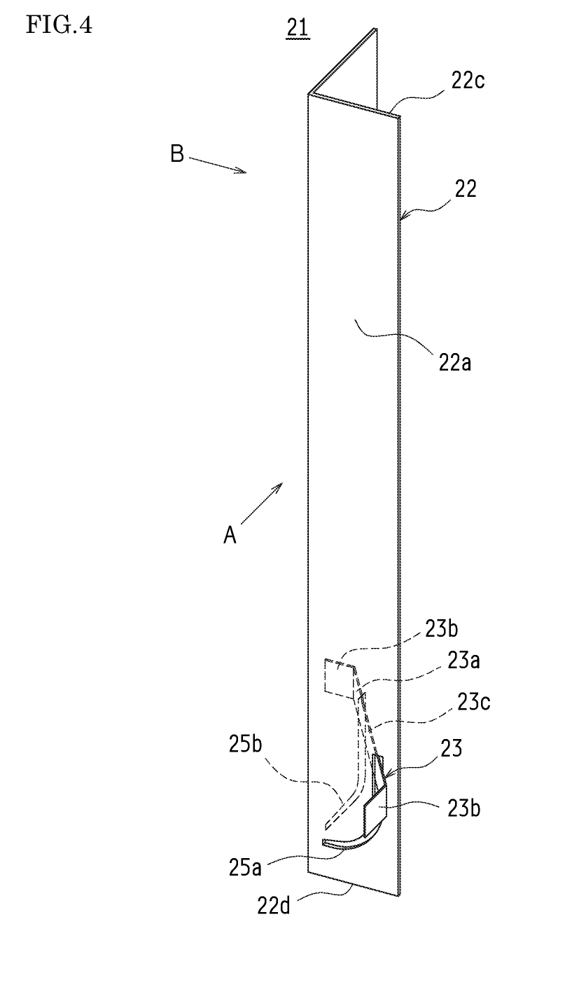

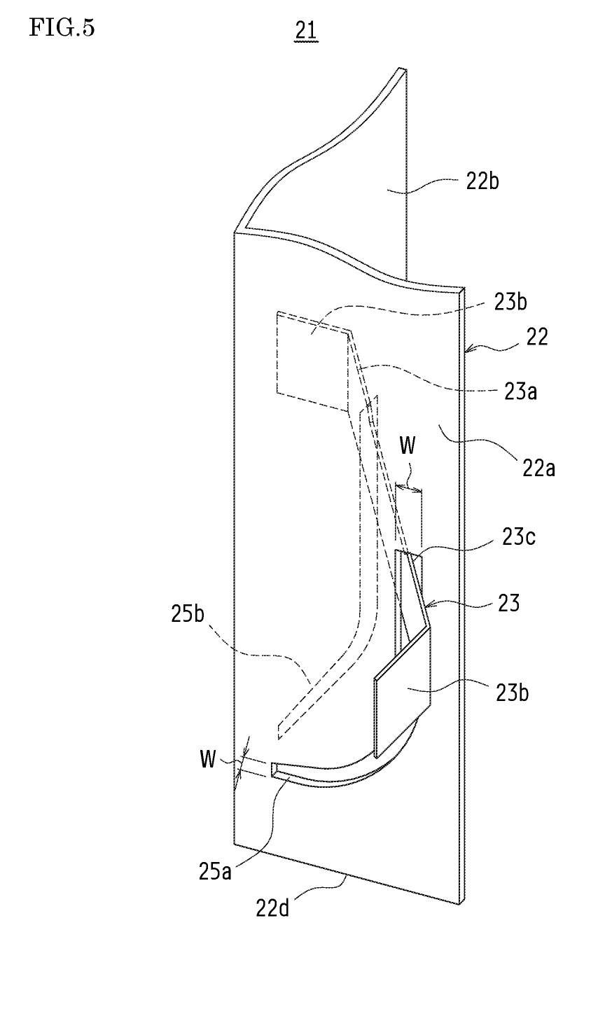

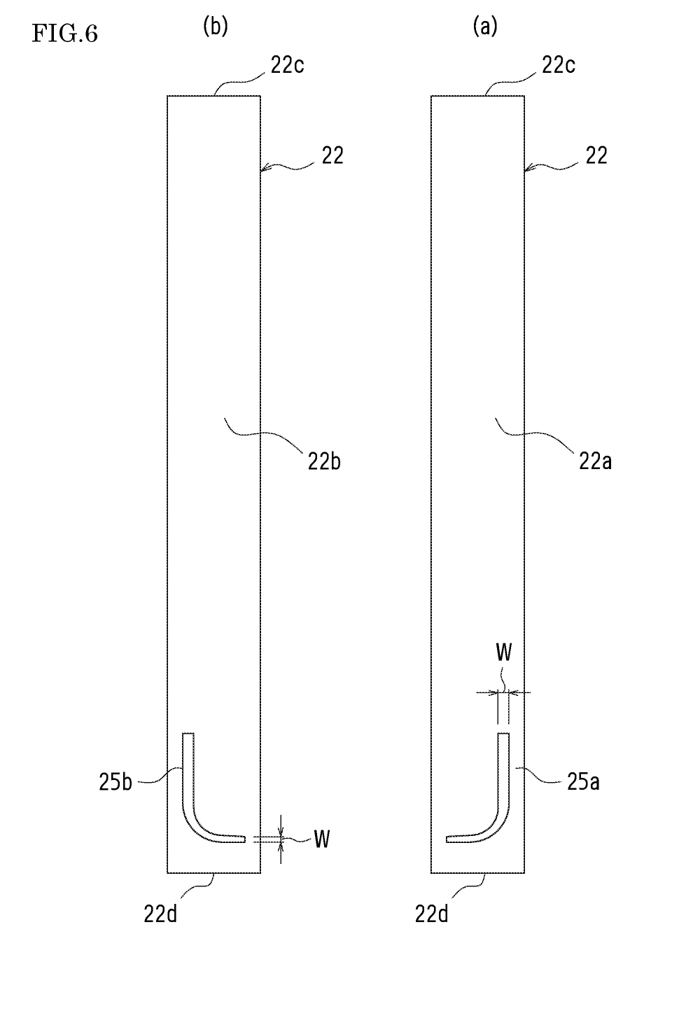

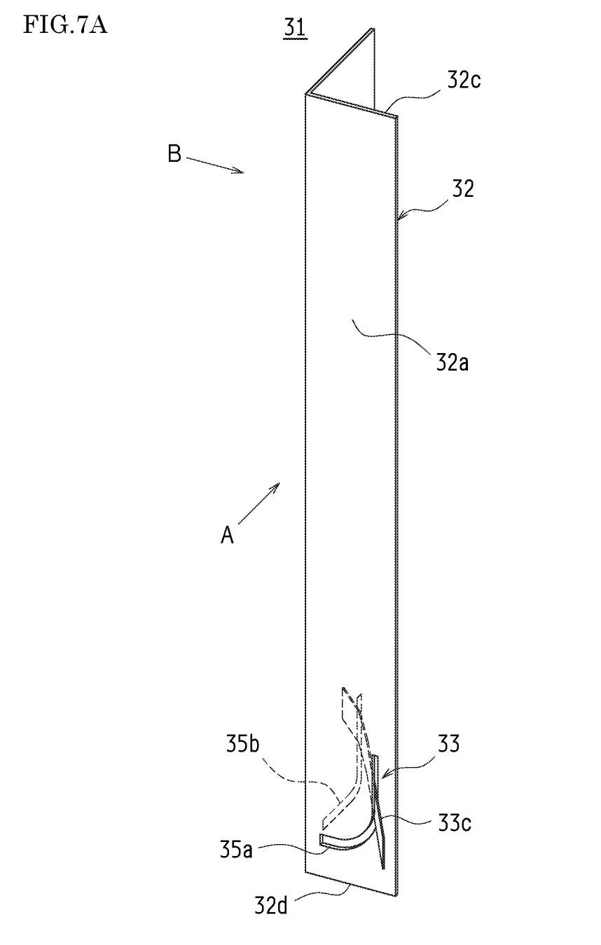

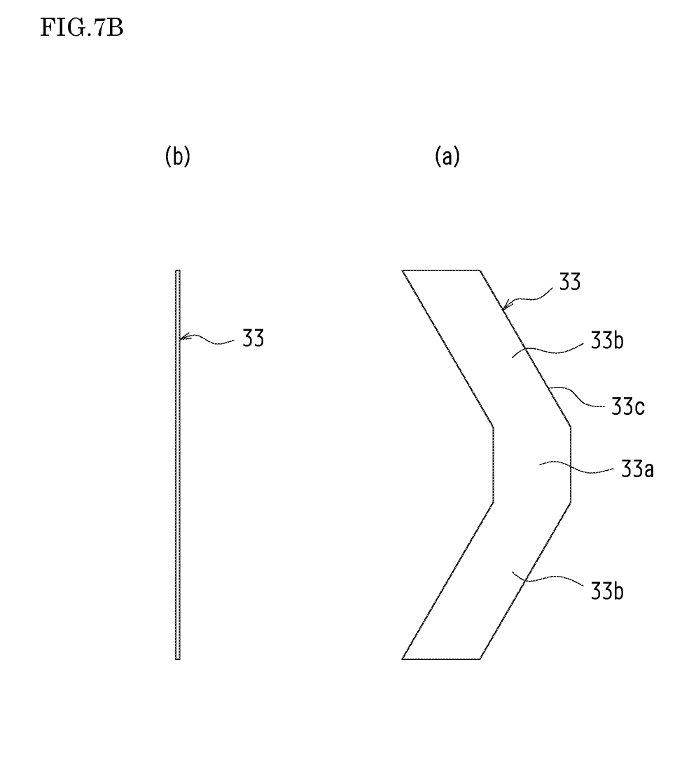

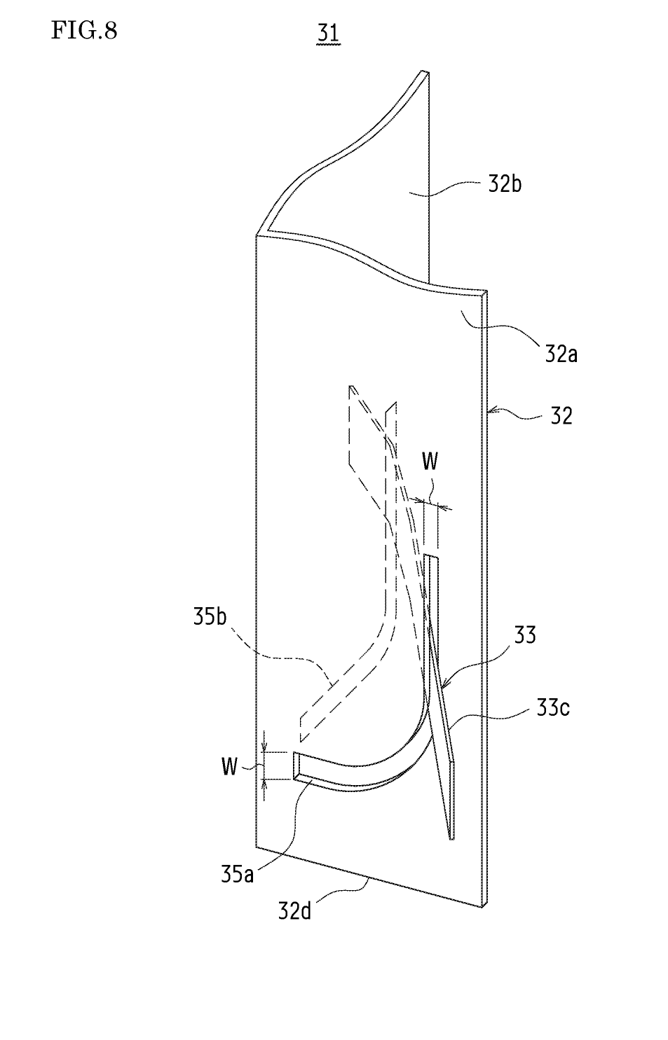

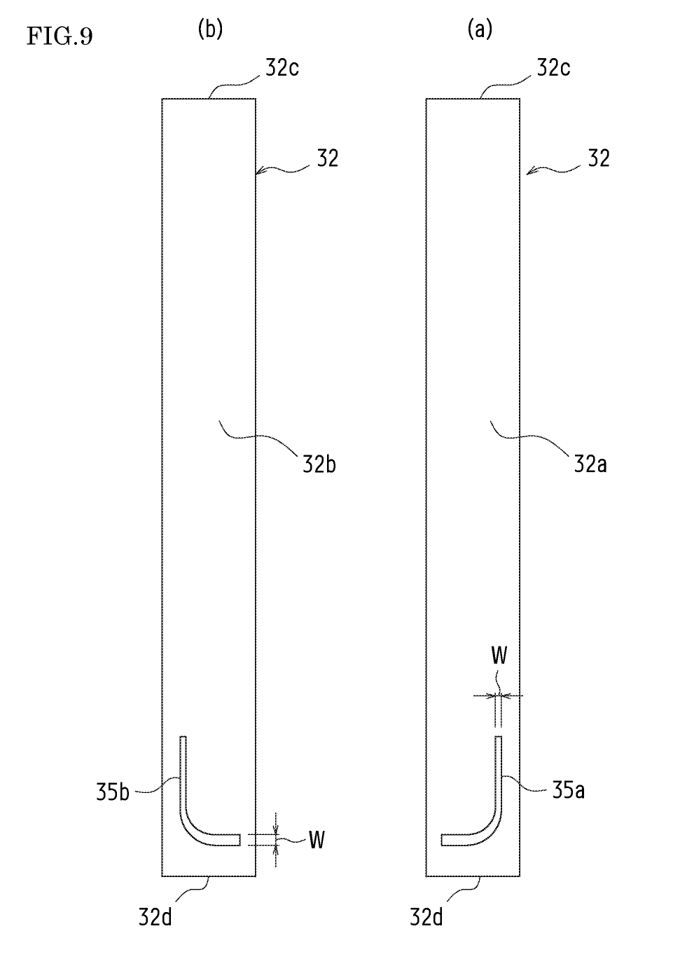

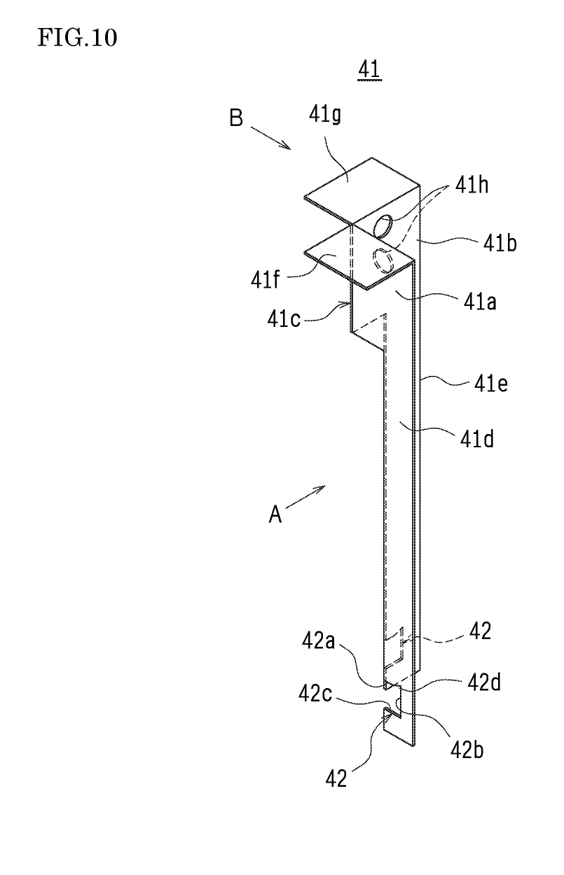

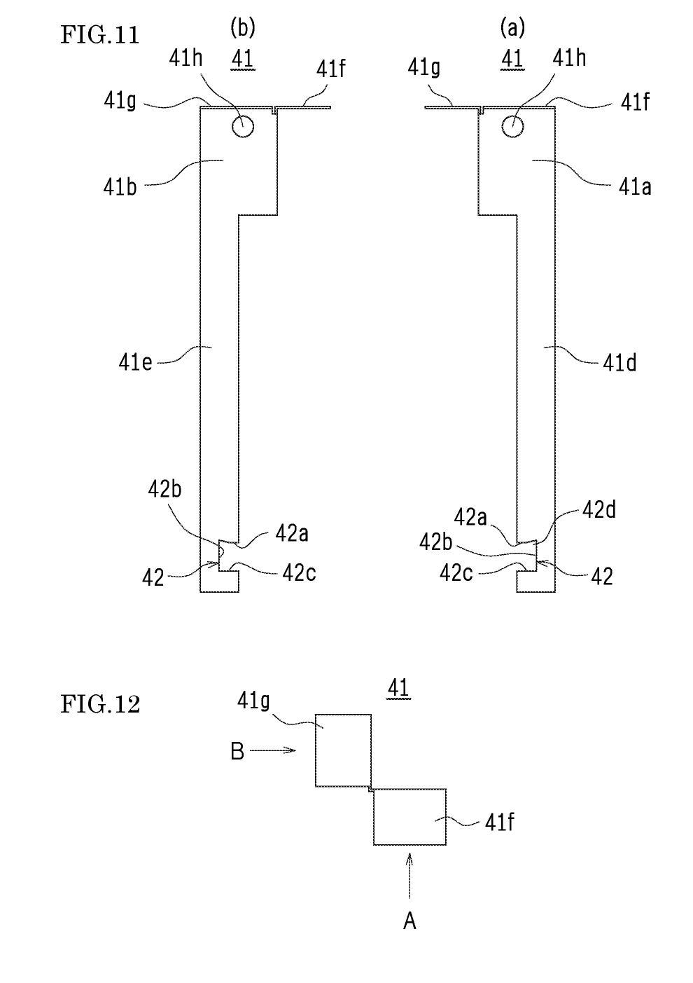

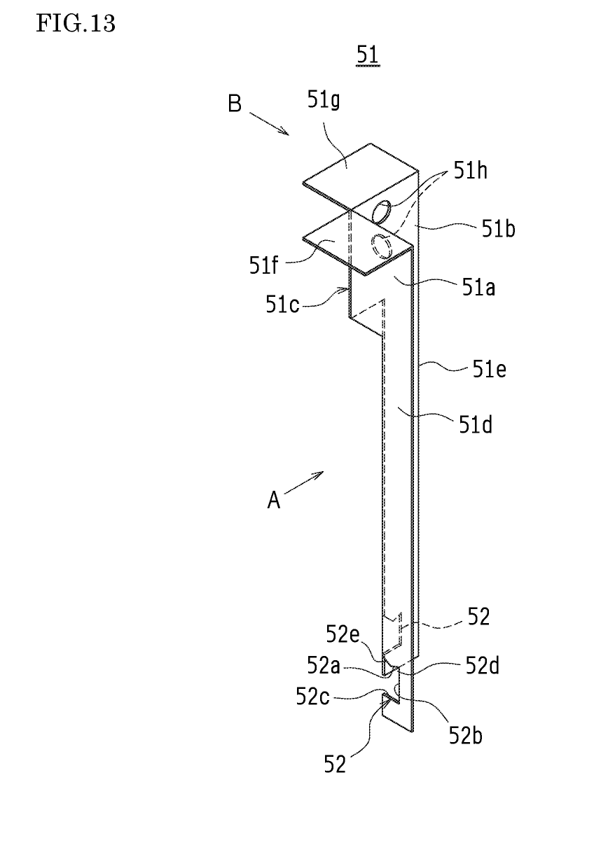

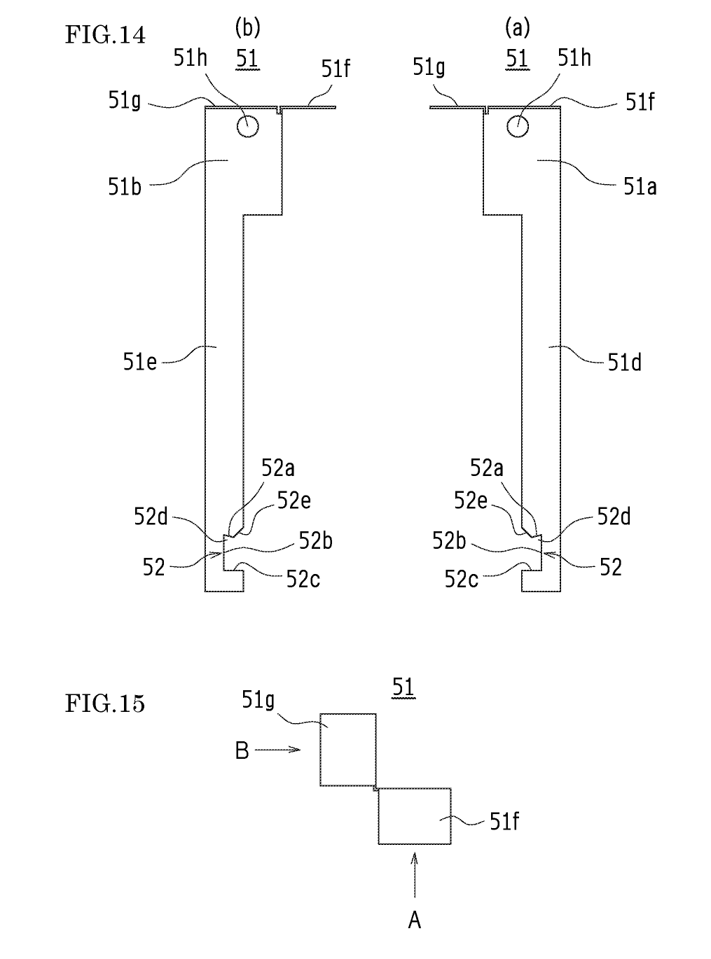

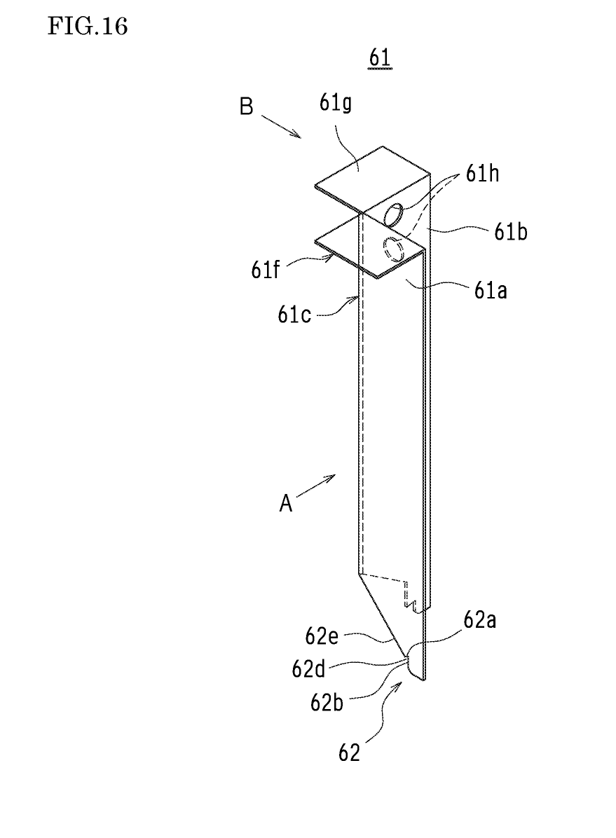

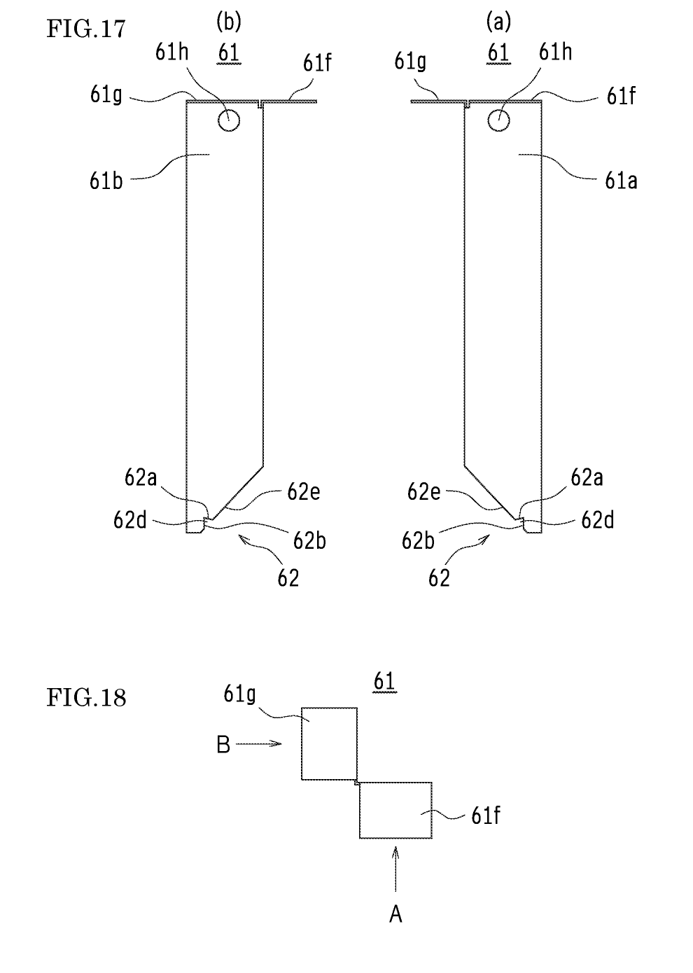

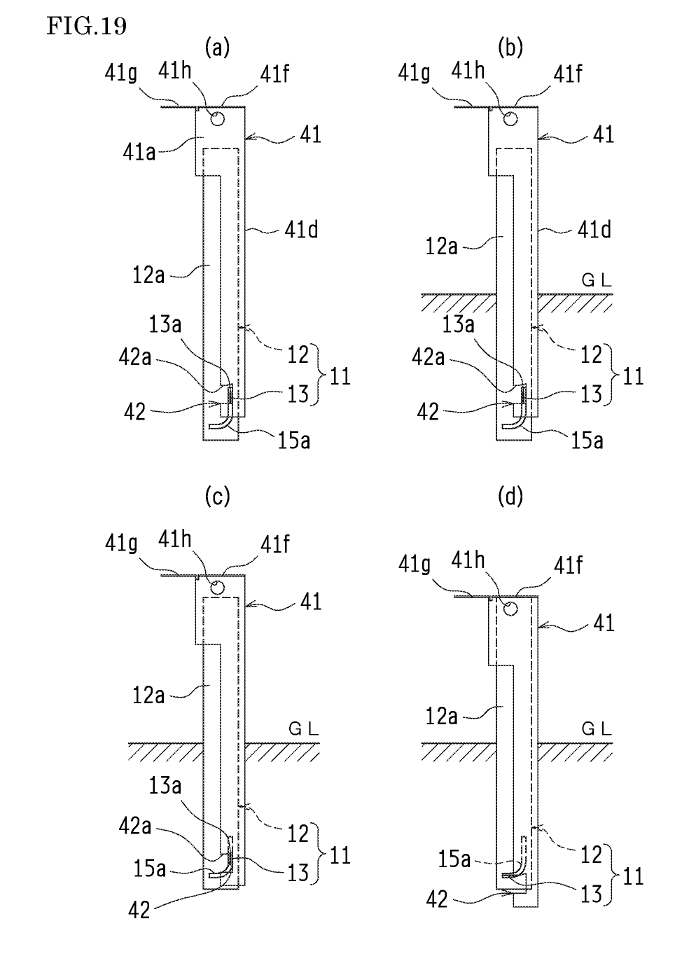

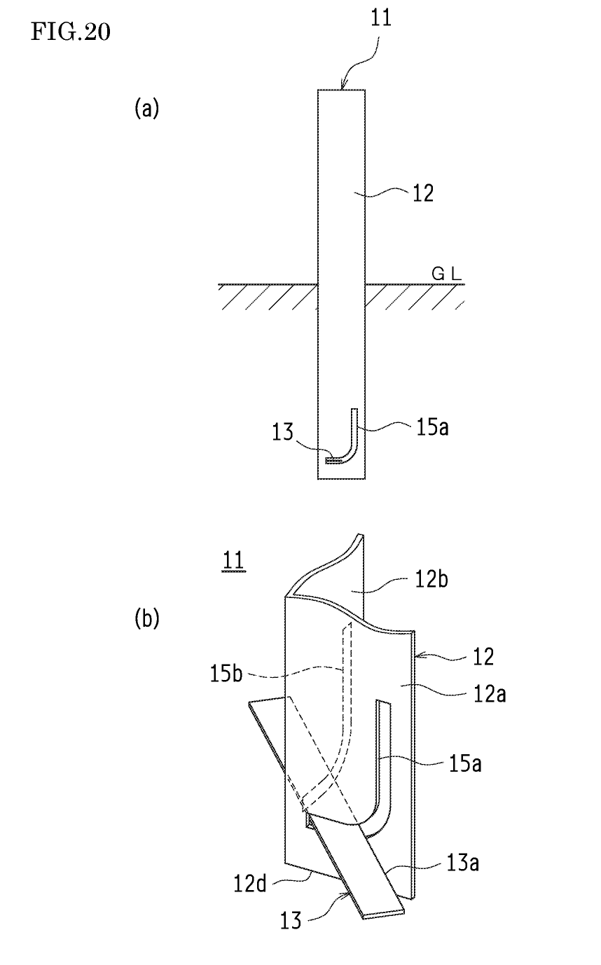

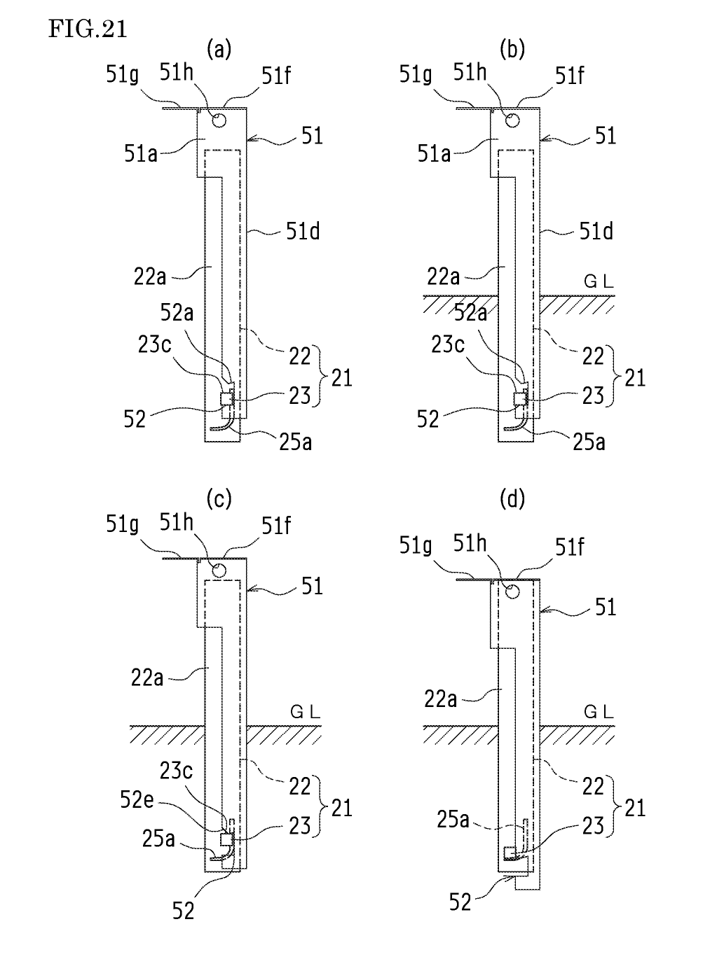

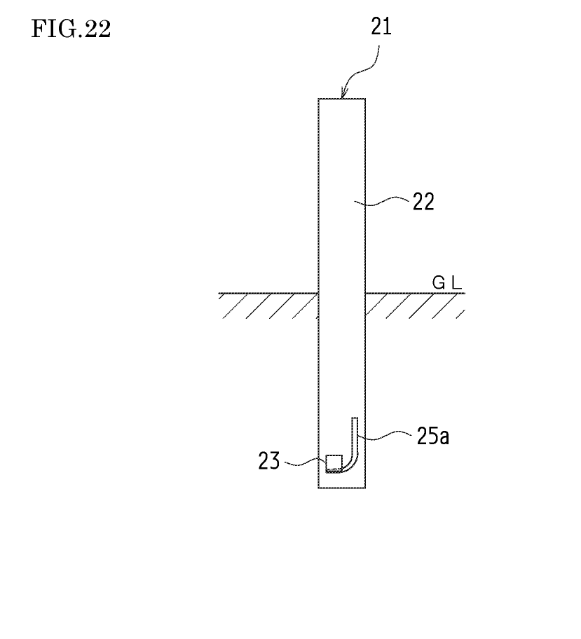

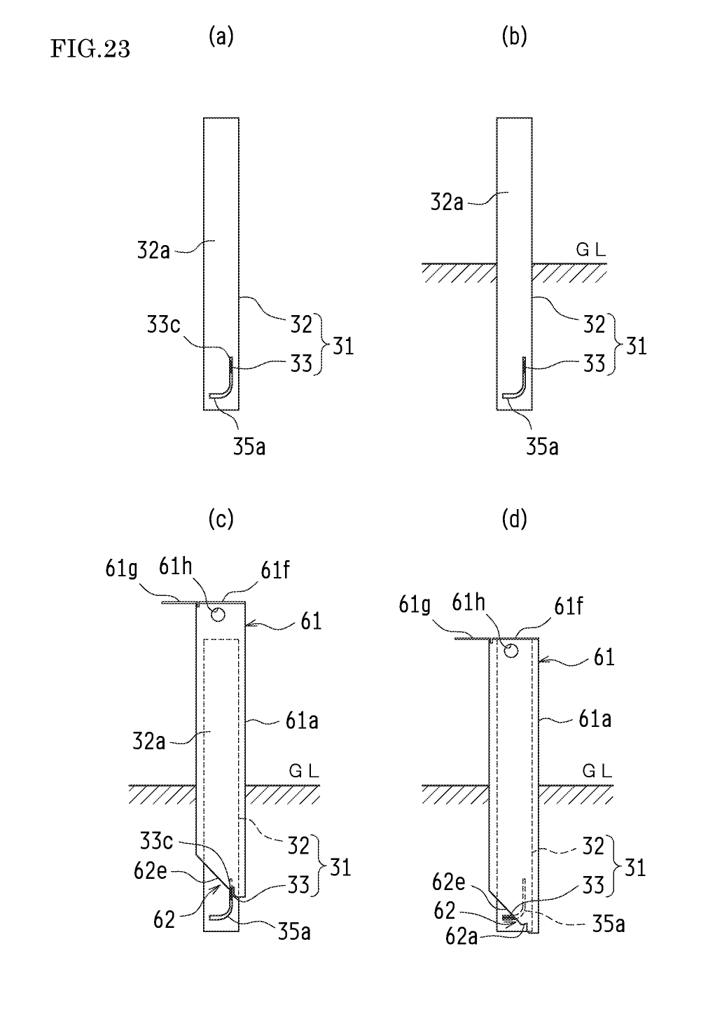

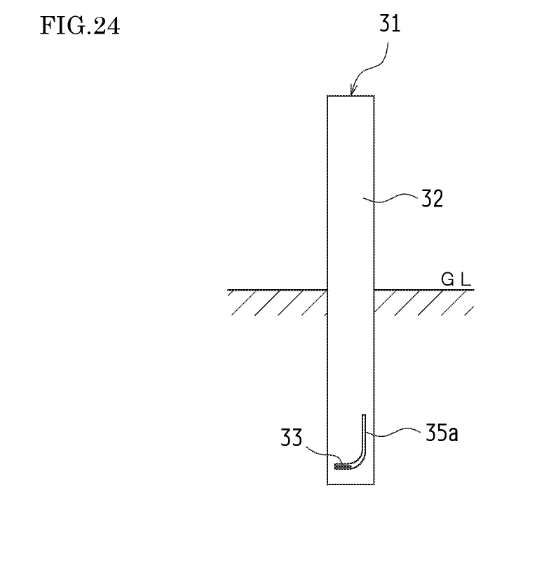

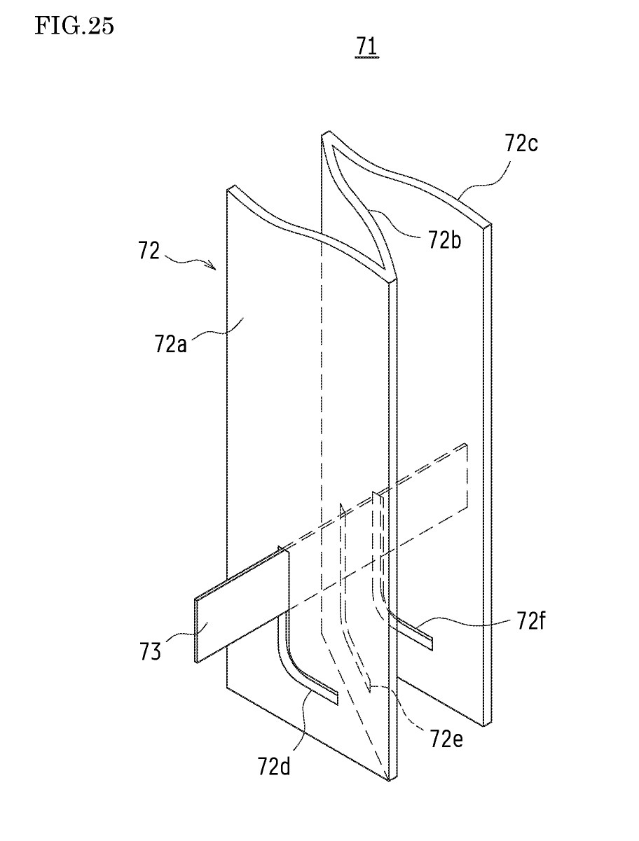

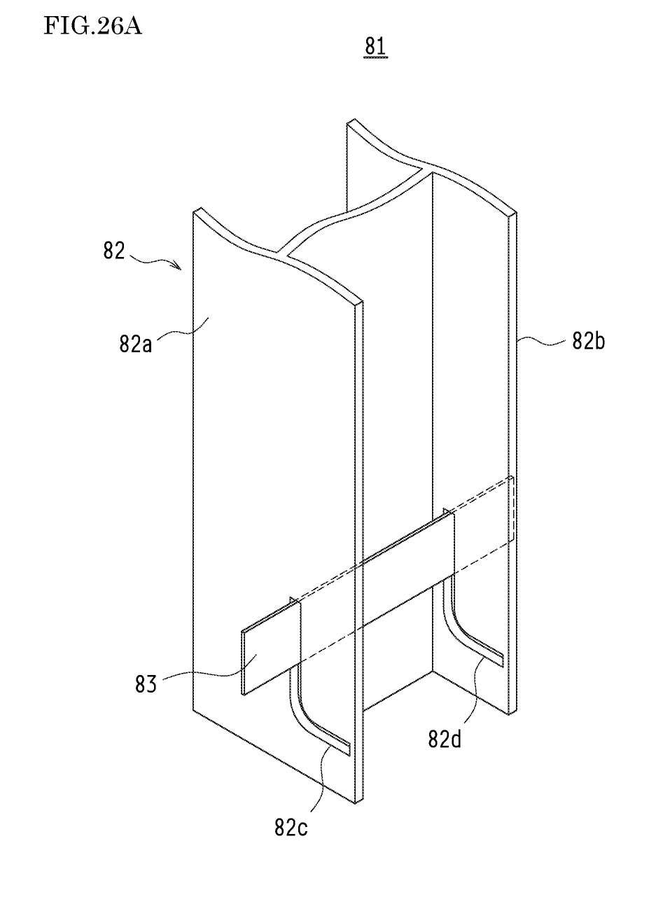

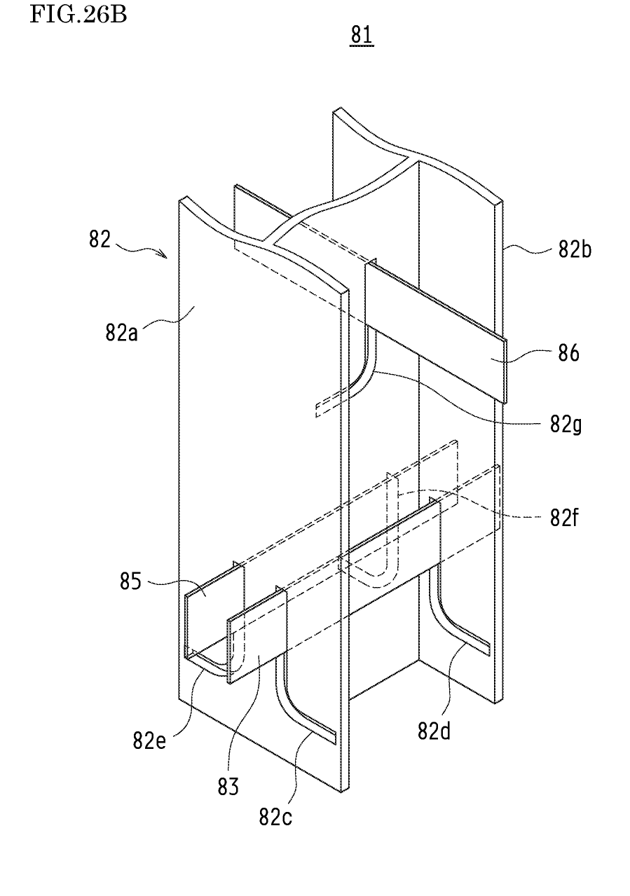

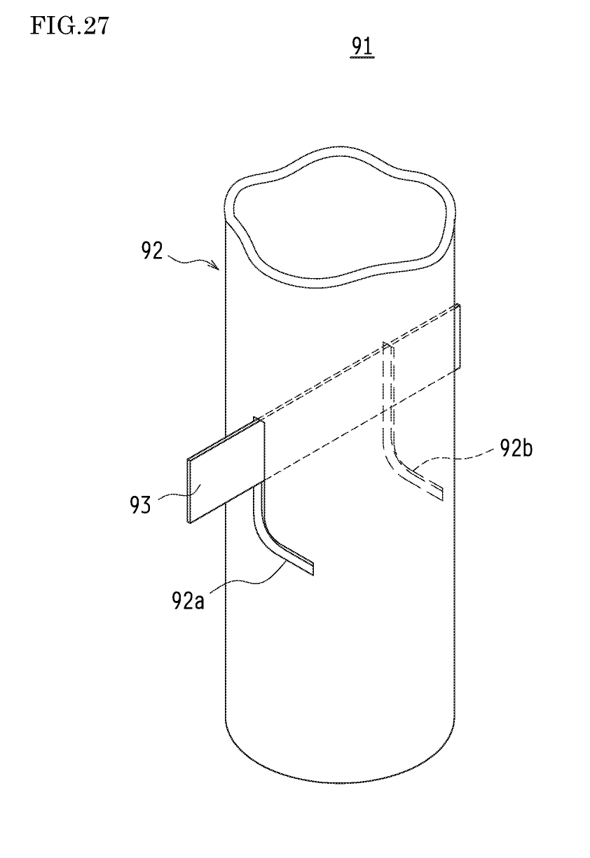

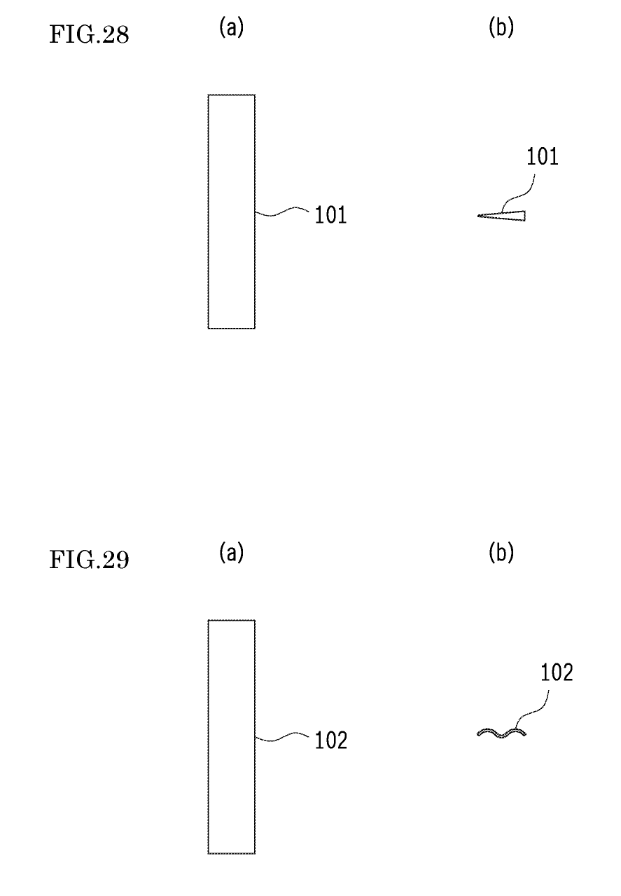

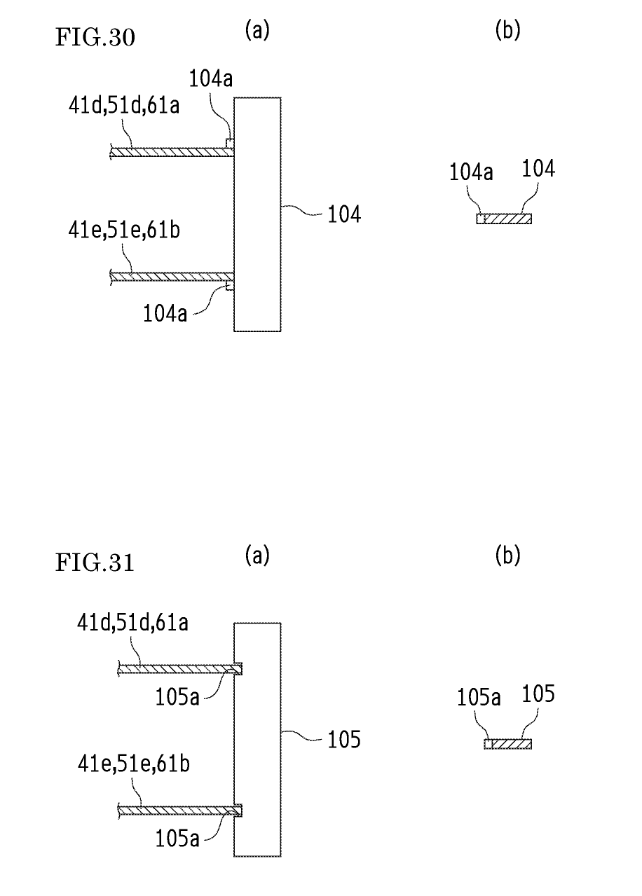

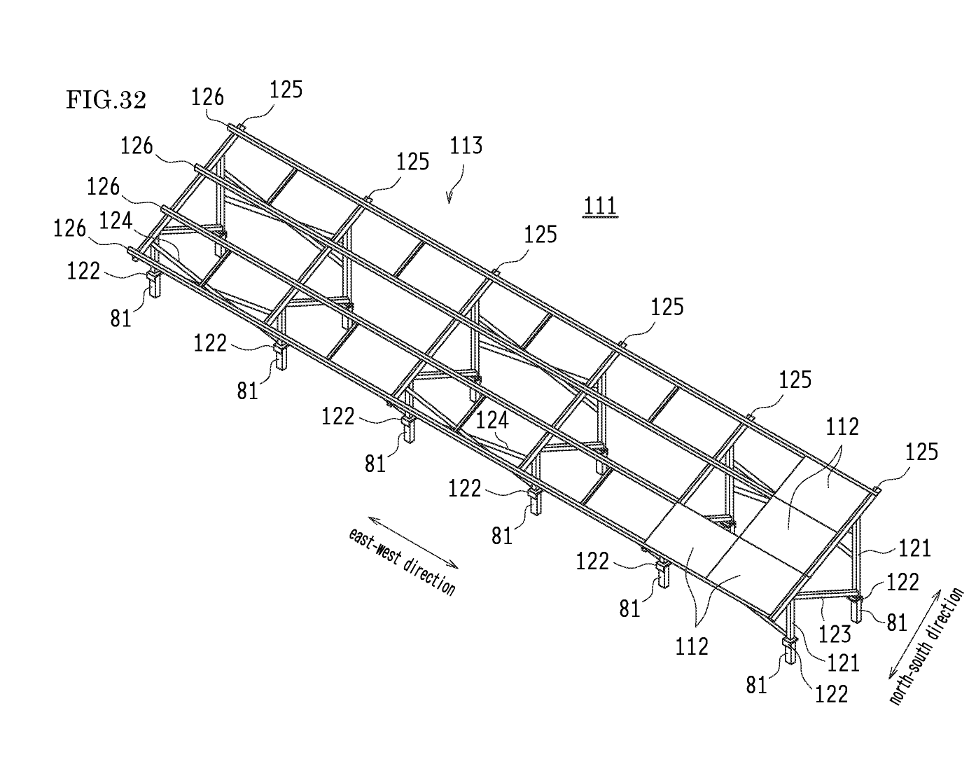

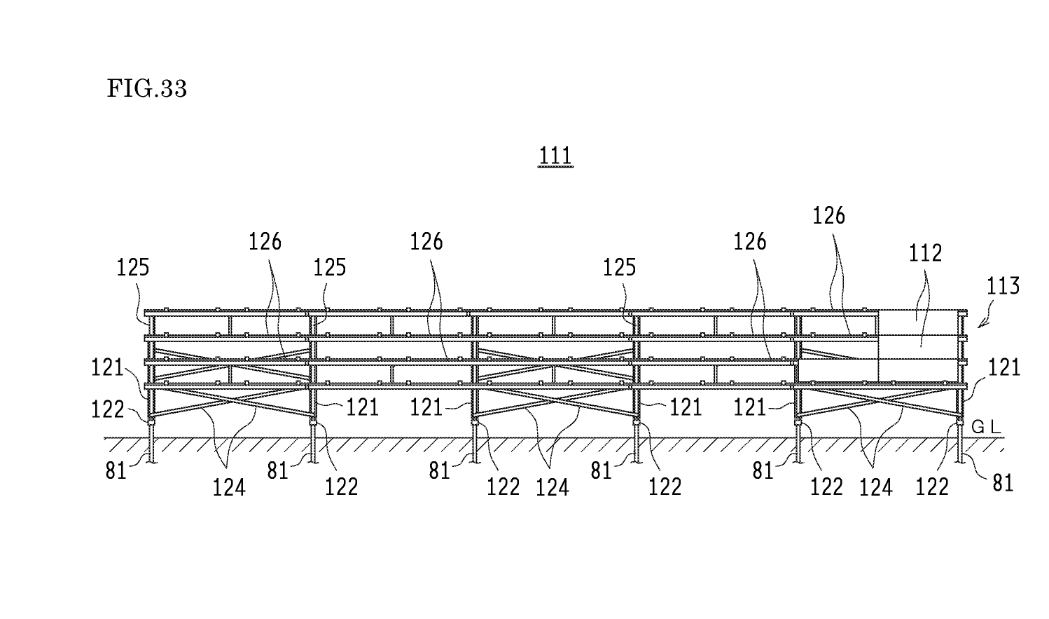

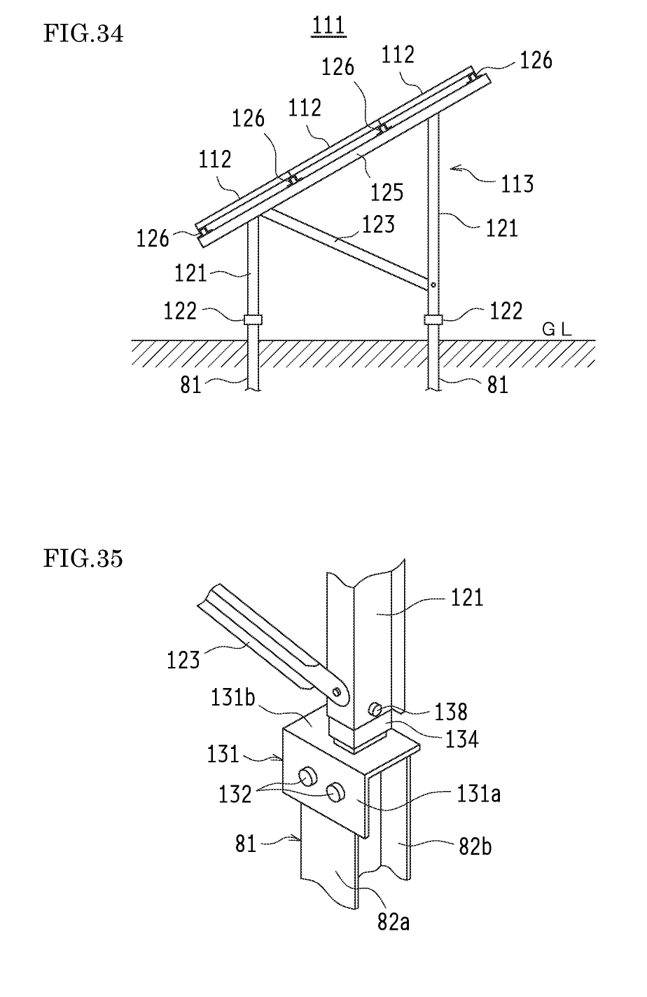

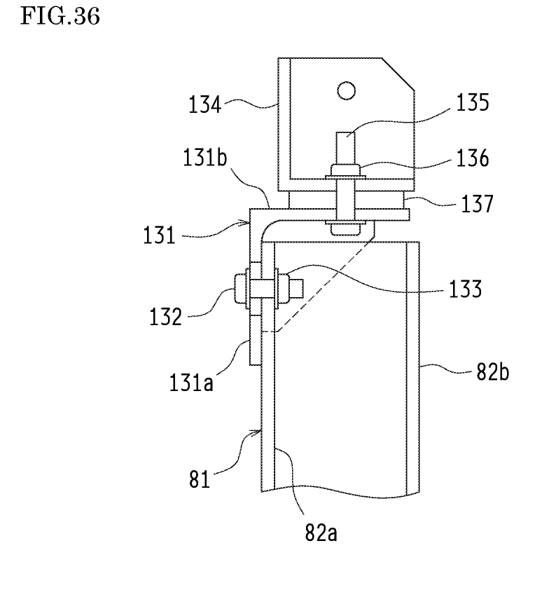

### BRIEF DESCRIPTION OF THE DRAWINGS

[FIG. 1] FIG. 1 is a perspective view of a pile in the first embodiment of the present invention.

[FIG. 2] FIG. 2 is an enlarged perspective view of a leading end of the pile in the first embodiment.

[FIG. 3] FIGS. 3(a) and 3(b) are side views of the pile in the first embodiment, as seen from two directions indicated by arrows A and B in FIG. 1.

[FIG. 4] FIG. 4 is a perspective view of a pile in the second embodiment of the present invention.

[FIG. 5] FIG. 5 is an enlarged perspective view of a leading end of the pile in the second embodiment.

[FIG. 6] FIGS. 6(a) and 6(b) are side views of the pile in the second embodiment, as seen from two directions indicated by arrows A and B in FIG. 4.

[FIG. 7A] FIG. 7A is a perspective view of a pile in the third embodiment of the present invention.

[FIG. 7B] FIGS. 7B(a) and 7B(b) are a plan view and a sectional view, respectively, showing a plate-like member in the third embodiment.

[FIG. 8] FIG. 8 is an enlarged perspective view of a leading end of the pile in the third embodiment.

[FIG. 9] FIGS. 9(a) and 9(b) are side views of the pile in the third embodiment, as seen from two directions indicated by arrows A and B in FIG. 7A.

[FIG. 10] FIG. 10 is a perspective view of a pile installation jig in the fourth embodiment of the present invention.

[FIG. 11] FIGS. 11(a) and 11(b) are side views of the pile installation jig in the fourth embodiment, as seen from two directions indicated by arrows A and B in FIG. 10.

[FIG. 12] FIG. 12 is a top plan view of the pile installation jig in the fourth embodiment.

[FIG. 13] FIG. 13 is a perspective view of a pile installation jig in the fifth embodiment of the present invention.

[FIG. 14] FIGS. 14(a) and 14(b) are side views of the pile installation jig in the fifth embodiment, as seen from two directions indicated by arrows A and B in FIG. 13.

[FIG. 15] FIG. 15 is a top plan view of the pile installation jig in the fifth embodiment.

[FIG. 16] FIG. 16 is a perspective view of a pile installation jig in the sixth embodiment of the present invention.

[FIG. 17] FIGS. 17(a) and 17(b) are side views of the pile installation jig in the sixth embodiment, as seen from two directions indicated by arrows A and B in FIG. 16.

[FIG. 18] FIG. 18 is a top plan view of the pile installation jig in the sixth embodiment.

[FIG. 19] FIGS. 19(a)-19(d) illustrate, step by step, an installation method in the seventh embodiment, for installing the pile in the first embodiment with use of the pile installation jig in the fourth embodiment.

[FIG. 20] FIG. 20(a) illustrates a step following the steps illustrated in FIGS. 19(a)-19(d). FIG. 20(b) is a perspective view showing a state of a plate-like member.

[FIG. 21] FIGS. 21(a)-21(d) illustrate, step by step, the installation method in the seventh embodiment, for installing the pile in the second embodiment with use of the pile installation jig in the fifth embodiment.

[FIG. 22] FIG. 22 illustrates a step following the steps illustrated in FIGS. 21(a)-21(d).

[FIG. 23] FIG. 23(a)-23(d) illustrate, step by step, an installation method in the eighth embodiment, for installing the pile in the third embodiment with use of the pile installation jig in the sixth embodiment.

[FIG. 24] FIG. 24 illustrates a step following the steps illustrated in FIGS. 23(a)-23(d).

[FIG. 25] FIG. 25 is an enlarged perspective view of a leading end of a pile in the ninth embodiment.

[FIG. 26A] FIG. 26A is an enlarged perspective view of a leading end of a pile in the tenth embodiment.

[FIG. 26B] FIG. 26 is a perspective view showing a modified example of the pile in FIG. 26A.

[FIG. 27] FIG. 27 is an enlarged perspective view of a leading end of a pile in the eleventh embodiment.

[FIG. 28] FIGS. 28(a) and 28(b) are a plan view and a sectional view, respectively, showing a first modified example of the plate-like member.

[FIG. 29] FIGS. 29(a) and 29(b) are a plan view and a sectional view, respectively, showing a second modified example of the plate-like member.

[FIG. 30] FIGS. 30(a) and 30(b) are a plan view and a sectional view, respectively, showing a third modified example of the plate-like member.

[FIG. 31] FIGS. 31(a) and 31(b) are a plan view and a sectional view, respectively, showing a fourth modified example of the plate-like member.

[FIG. 32] FIG. 32 is a perspective view of a photovoltaic system in the twelfth embodiment to which the piles according to the present invention are applied.

[FIG. 33] FIG. 33 is a rear view of the photovoltaic system in the twelfth embodiment.

[FIG. 34] FIG. 34 is a side view of the photovoltaic system in the twelfth embodiment.

[FIG. 35] FIG. 35 is a perspective view of a joint unit for connecting a column to an upper end of each pile in the photovoltaic system in the twelfth embodiment.

[FIG. 36] FIG. 36 is a sectional view of the joint unit in FIG. 35.

### MODE FOR CARRYING OUT THE INVENTION

Hereinafter, embodiments of the present invention are described in detail with reference to the attached drawings.

FIG. 1 is a perspective view of a pile in the first embodiment of the present invention. FIG. 2 is an enlarged perspective view of a leading end of the pile in the first embodiment. FIGS. 3(a) and 3(b) are side views of the pile in the first embodiment, as seen from two directions indicated by arrows A and B in FIG. 1.

As shown in FIGS. 1, 2, 3(a) and 3(b), a pile 11 in the first embodiment has a pile main body 12 and a plate-like member 13. The pile main body 12 is a columnar member made of an L-shaped steel having an L-shaped cross section, and has two walls 12a, 12b which extend in a longitudinal direction of the pile main body 12. The walls 12a, 12b have corresponding grooves 15a, 15b formed on a leading end 12d side of the pile main body 12. In this context, a head 12c means an upper end of the pile main body 12, and the leading end 12d means a lower end of the pile main body 12, as seen in a state where the pile composed of the pile main body 12 is buried. The grooves 15a, 15b extend in a longitudinal direction from a head 12c side to the leading end 12d side of the pile main body 12, and curve smoothly in a direction transverse to the longitudinal direction as the grooves approach the leading end 12d of the pile main body 12, thus approximately assuming a shape of the letter J.

The grooves 15a, 15b formed in the corresponding walls 12a, 12b are longitudinally aligned with each other in the pile main body 12, with their curves (the J-shaped curves) oriented in the same direction. In other words, suppose that there is a virtual symmetrical plane which passes an L-shaped corner of the pile main body 12 and a midpoint between the walls 12a, 12b and which extends in the longitudinal direction of the pile main body 12, the grooves 15a, 15b are formed in plane symmetry about the virtual symmetrical plane.

The width W of the grooves 15a, 15b is fixed. The peripheral edges of the grooves 15a, 15b are composed of an arc. In fact, the peripheral edges of the grooves 15a, 15b may be composed of an oval, hyperbola, parabola and other curved lines, or may be composed of a polygonal line containing a series of straight and/or curved lines. Any type of curved line or polygonal line is acceptable as far as it curves generally smoothly. In addition, near the ends of the grooves 15a, 15b in the direction transverse to the longitudinal direction of the pile main body 12, the peripheral edges of the grooves 15a, 15b are oriented in a horizontal direction or an inclined near-horizontal direction.

The plate-like member 13 is a rectangular steel plate. The plate-like member 13 has a greater width than the greatest gap between the grooves 15a, 15b, and a smaller thickness than the width W of the grooves 15a, 15b. The plate-like member 13 penetrates the grooves 15a, 15b in a movable manner along the grooves 15a, 15b, and both sides of the plate-like member 13 project outwardly from the walls 12a, 12b.

The length and the thickness of the pile main body 12 can be suitably set in accordance with the type and the strata composition of the ground into which the pile main body 12 is driven, the depth of the pile main body 12 to be driven in, and other like conditions, namely, in accordance with the conditions of use of the pile 11. The length and the thickness of the plate-like member 13 can be suitably set in accordance with the size of the pile main body 12 and the conditions of use of the pile 11.

FIG. 4 is a perspective view of a pile in the second embodiment of the present invention. FIG. 5 is an enlarged perspective view of a leading end of the pile in the second embodiment. FIGS. 6(a) and 6(b) are side views of the pile in the second embodiment, as seen from two directions indicated by arrows A and B in FIG. 4.

As shown in FIGS. 4, 5, 6(a) and 6(b), a pile 21 in the second embodiment of the present invention has a pile main body 22 and a plate-like member 23. The shape of the pile main body 22 is substantially the same as that of the pile main body 12 in the first embodiment. The pile main body 22 has two walls 22a, 22b which extend in a longitudinal direction of the pile main body 22, and also has J-shaped grooves 25a, 25b formed in the corresponding walls 22a, 22b on a leading end 22d side of the pile main body 22. The grooves 25a, 25b formed in the corresponding walls 22a, 22b are longitudinally aligned with each other in the pile main body 22, with their curves (the J-shaped curves) oriented in the same direction.

In this embodiment, the shape of the grooves 25a, 25b in the pile main body 22 is different from that of the grooves 15a, 15b in the pile main body 12 in the first embodiment. The shape of the plate-like member 23 is also different from that of the plate-like member 13 in the first embodiment.

For the purpose of description, the ends of the grooves 25a, 25b in the longitudinal direction of the pile main body 22 are defined as upper ends, whereas the ends of the grooves 25a, 25b in a direction transverse to the longitudinal direction of the pile main body 22 are defined as lower ends. The width W of the grooves 25a, 25b is fixed from the upper ends to starting points of their smooth curves which turn into the direction transverse to the longitudinal direction of the pile main body 22. Then, the width W decreases gradually from midway in the curves to the lower ends of the grooves 25a, 25b. Near the lower ends, the width W of the grooves 25a, 25b is substantially the same as or slightly greater than the thickness of the plate-like member 23.

The plate-like member 23 is made of a rectangular steel plate in which two portions near both ends thereof are bent in the same direction. Hence, the plate-like member 23 has a flat central portion 23a and bent portions 23b. The central portion 23a is longer than the greatest gap between the grooves 25a, 25b. The plate-like member 23 penetrates the grooves 25a, 25b in a movable manner along the grooves 25a, 25b, and both sides of the central portion 23a and the bent portions 23b project outwardly from the walls 22a, 22b.

The length and the thickness of the pile main body 22 are suitably set in accordance with the conditions of use of the pile 21. The length and the thickness of the plate-like member 23 are suitably set in accordance with the size of the pile main body 22 and the conditions of use of the pile 21.

FIG. 7A is a perspective view of a pile in the third embodiment of the present invention. FIGS. 7B(a) and 7B(b) are a plan view and a sectional view, respectively, showing a plate-like member for the pile in the third embodiment. FIG. 8 is an enlarged perspective view of a leading end of the pile in the third embodiment. FIGS. 9(a) and 9(b) are side views of the pile in the third embodiment, as seen from two directions indicated by arrows A and B in FIG. 7A.

As shown in FIGS. 7A, 7B, 8, 9(a) and 9(b), a pile 31 in the third embodiment of the present invention has a pile main body 32 and a plate-like member 33. The shape of the pile main body 32 is substantially the same as that of the pile main body 12 in the first embodiment. The pile main body 32 has two walls 32a, 32b which extend in a longitudinal direction of the pile main body 32, and also has J-shaped grooves 35a, 35b formed in the corresponding walls 32a, 32b on a leading end 32d side of the pile main body 32. Suppose that there is a virtual symmetrical plane which passes an L-shaped corner of the pile main body 32 and a midpoint between the walls 32a, 32b and which extends in the longitudinal direction of the pile main body 32, the grooves 35a, 35b are formed in plane symmetry about the virtual symmetrical plane.

In this embodiment, the shape of the grooves 35a, 35b in the pile main body 22 is different from that of the grooves 15a, 15b in the pile main body 12 in the first embodiment. The shape of the plate-like member 33 is also different from that of the plate-like member 13 for the pile main body 12 in the first embodiment.

For the purpose of description, the ends of the grooves 35a, 35b in the longitudinal direction of the pile main body 32 are defined as upper ends, whereas the ends of the grooves 35a, 35b in a direction transverse to the longitudinal direction of the pile main body 32 are defined as lower ends. The width W of the grooves 35a, 35b is substantially the same as or slightly greater than the thickness of the plate-like member 33, from the upper ends of the grooves 35a, 35b to starting points of their smooth curves which turn into the direction transverse to the longitudinal direction of the pile main body 32. Then, the width W of the grooves 35a, 35b increases gradually from midway in the curves into the direction transverse to the longitudinal direction of the pile main body 32. When the width W reaches a predetermined width which is sufficiently wider than the thickness of the plate-like member 33, the predetermined width is maintained to the lower ends of the J-shaped grooves 35a, 35b.

The plate-like member 33 is made of a roughly V-shaped steel plate, and has a rectangular central portion 33a and arms 33b. The plate-like member 33 is longer than the greatest gap between the grooves 35a, 35b. The plate-like member 33 penetrates the grooves 35a, 35b in a movable manner along the grooves 35a, 35b, and both sides of the plate-like member 33 project outwardly from the walls 32a, 32b.

The length and the thickness of the pile main body 32 are suitably set in accordance with the conditions of use of the pile 31. The length and the thickness of the plate-like member 33 are suitably set in accordance with the size of the pile main body 32 and the conditions of use of the pile 31.

Next, the fourth embodiment of the present invention concerns a pile installation jig. FIG. 10 is a perspective view of a pile installation jig in the fourth embodiment of the present invention. FIGS. 11(a) and 11(b) are side views of the pile installation jig in the fourth embodiment of the present invention, as seen from two directions indicated by arrows A and B in FIG. 10. FIG. 12 is a top plan view of the pile installation jig in the fourth embodiment.

As shown in FIGS. 10, 11(a), 11(b) and 12, a pile installation jig 41 in the fourth embodiment of the present invention has an L-shaped part 41c composed of two walls 41a, 41b connected in the shape of the letter L, arms 41d, 41e which extend downwardly from lower ends of the corresponding walls 41a, 41b and which are separated from each other, and top panels 41f, 41g which are formed at upper ends of the corresponding walls 41a, 41b in an outwardly bent fashion. A bore 41h is formed in each of the walls 41a, 41b. A notch 42 is formed in each of the arms 41d, 41e, at a side edge near a lower end thereof.

Each notch 42 is defined by an upper abutment edge 42a, a side edge 42b, and a lower receiving edge 42c. The abutment edge 42a is slightly curved and inclined upwardly toward the side edge 42b, making an acute angle between the abutment edge 42a and the side edge 42b and providing a retention space 42d therebetween.

The pile installation jig 41 in the fourth embodiment is applicable to any of the piles 11, 21, 31 in the first to third embodiments described above. The length and the thickness of the pile installation jig 41 can be suitably set in accordance with the size and the conditions of use of the pile to which the pile installation jig 41 is applied.

FIG. 13 is a perspective view of a pile installation jig in the fifth embodiment of the present invention. FIGS. 14(a) and 14(b) are side views of the pile installation jig in the fifth embodiment of the present invention, as seen from two directions indicated by arrows A and B in FIG. 13. FIG. 15 is a top plan view of the pile installation jig in the fifth embodiment.

As shown in FIGS. 13, 14(a), 14(b) and 15, a pile installation jig 51 in the fifth embodiment of the present invention has substantially the same shape as the pile installation jig 41 in the fourth embodiment described above. Namely, the pile installation jig 51 has an L-shaped part 51c composed of two walls 51a, 51b connected in the shape of the letter L, arms 51d, 51e which extend downwardly from lower ends of the corresponding walls 51a, 51b, and top panels 51f, 51g which are formed at upper ends of the corresponding walls 51a, 51b in an outwardly bent fashion. A bore 51h is formed in each of the walls 51a, 51b.

A notch 52 is formed each of the arms 51d, 51e, at a side edge near a lower end thereof. However, the shape of each notch 52 is different from that of the notches 42 formed at the side edges near the lower ends of the arms 41d, 41e in the fourth embodiment.

Each notch 52 is defined by an upper abutment edge 52a, a side edge 52b, a lower receiving edge 52c, and an inclined edge 52e which is continuous from the abutment edge 52a to a side edge of the corresponding one of the arms 51d, 51e. The abutment edge 52a is slightly curved and inclined upwardly toward the side edge 52b, making an acute angle between the abutment edge 52a and the side edge 52b and providing a retention space 52d therebetween. As the inclined edge 52e extends toward a head of the pile installation jig 51, the inclined edge 52e is inclined in a direction transverse to a longitudinal direction of the pile installation jig 51 in such a manner as to be more distant from the abutment edge 52a.

The pile installation jig 51 in the fifth embodiment is applicable to any of the piles 11, 21, 31 in the first to third embodiments described above. The length and the thickness of the pile installation jig 51 can be suitably set in accordance with the size and the conditions of use of the pile to which the pile installation jig 51 is applied.

FIG. 16 is a perspective view of a pile installation jig in the sixth embodiment of the present invention. FIGS. 17(a) and 17(b) are side views of the pile installation jig in the sixth embodiment, as seen from two directions indicated by arrows A and B in FIG. 16. FIG. 18 is a top plan view of the pile installation jig in the sixth embodiment.

As shown in FIGS. 16, 17(a), 17(b) and 18, the pile installation jig 61 in the sixth embodiment has substantially the same shape as the pile installation jig 41 in the fourth embodiment described above. Namely, the pile installation jig 61 has an L-shaped part 61c composed of two walls 61a, 61b connected in the shape of the letter L, and top panels 61f, 61g which are formed at upper ends of the corresponding walls 61a, 61b in an outwardly bent fashion. A bore 61h is formed in each of the walls 61a, 61b. A notch 62 is formed in each of the walls 61a, 61b, at a lower end thereof.

In this embodiment, the pile installation jig 61 has no equivalent to the arms 41d, 41e in the fourth embodiment. Instead, the walls 61a, 61b are extended by the length of the arms 41d, 41e in the fourth embodiment. In addition, the shape of the notches 62 formed at the lower ends of the walls 61a, 61b is different from that of the notches 42 formed at the side edges near the lower ends of the arms 41d, 41e in the fourth embodiment.

Each notch 62 is defined by an upper abutment edge 62a, a side edge 62b, and an inclined edge 62e which is continuous from the abutment edge 62a to a side edge of the corresponding one of the walls 61a, 61b. The abutment edge 62a is slightly curved and inclined upwardly toward the side edge 62b, making an acute angle between the abutment edge 62a and the side edge 62b and providing a retention space 62d therebetween. As the inclined edge 62e extends toward a head of the pile installation jig 61, the inclined edge 62e is inclined in a direction transverse to a longitudinal direction of the pile installation jig 61 in such a manner as to be more distant from the abutment edge 62a.

In this embodiment, the notches 62 have no equivalent to the receiving edges 42c of the notches 42 in the fourth embodiment and the receiving edges 52c of the notches 52 in the fifth embodiment.

The pile installation jig 61 in the sixth embodiment is applicable to any of the piles 11, 21, 31 in the first to third embodiments described above. The length and the thickness of the pile installation jig 61 can be suitably set in accordance with the size and the conditions of use of the pile to which the pile installation jig 61 is applied.

The following description concerns a method for installing a pile, as the seventh embodiment of the present invention. The installation method in the seventh embodiment of the present invention is a method for burying the pile 11 in the first embodiment (shown in FIGS. 1, 2, 3(a) and 3(b)) in the ground, with use of the pile installation jig 41 in the fourth embodiment (shown in FIGS. 10, 11(a), 11(b) and 12). This installation method is carried out by the steps shown in FIGS. 19(a)-19(d) and 20(a).

First, in the state shown in FIG. 19(a), the plate-like member 13 is inserted through the grooves 15a, 15b in the pile main body 12, with both sides of the plate-like member 13 projecting outwardly from the walls 12a, 12b. In this state, the L-shaped part 41c and the arms 41d, 41e of the pile installation jig 41 are overlaid on the outside of the walls 12a, 12b of the pile main body 12. Elongated portions including the walls 41a, 41b and the arms 41d, 41e are arranged in the longitudinal direction of the pile main body 12, and the both sides of the plate-like member 13 which project outwardly from the walls 12a, 12b are fitted in the notches 42 in the arms 41d, 41 of the pile installation jig 41. At this stage, the both sides of the plate-like member 13 abut on the receiving edges 42c of the notches 42 in the arms 41d, 41, so that the plate-like member 13 which is movable along the grooves 15a, 15b can be retained in place.

With the pile 11 and the pile installation jig 41 being combined as shown in FIG. 19(a), the pile 11 and the pile installation jig 41 are driven into the ground together as shown in FIG. 19(b). For example, the pile 11 and the pile installation jig 41 are driven into the ground by means of a striking hammer or like instrument mounted on construction equipment. For this process, an adaptor or the like may be interposed between the pile 11 and the pile installation jig 41. Such an adaptor or the like can prevent the pile 11 and the pile installation jig 41 from being vertically misaligned from each other and can allow the pile 11 and the pile installation jig 41 to be driven into the ground at the same time.

Referring next to FIGS. 19(c) and 19(d), the pile installation jig 41 is driven deeper into the ground by the length of the grooves 15a, 15b in the pile main body 12. For example, after the above-mentioned adaptor or the like is removed, the top panels 41f, 41g of the pile installation jig 41 are repeatedly hit by the striking hammer or like instrument so as to drive the pile installation jig 41 into the ground. When the top panels 41f, 41g of the pile installation jig 41 reach the head 12c of the pile main body 12, the hitting operation on the top panels 41f, 41g of the pile installation jig 41 is discontinued. By this process, the pile installation jig 41 is driven into the ground by the length of the grooves 15a, 15b of the pile main body 12.

Since the both sides of the plate-like member 13 are fitted in the notches 42 in the arms 41d, 41e of the pile installation jig 41, when the pile installation jig 41 is driven deeper into the ground by the length of the grooves 15a, 15b in the pile main body 12, the abutment edges 42a of the notches 42 in the arms 41d, 41e come into contact with a lateral edge 13a at the both sides of the plate-like member 13, push down the plate-like member 13 from the head 12c side of the pile main body 12, and cause the plate-like member 13 to move along the grooves 15a, 15b. During this process, since the lateral edge 13a at the both sides of the plate-like member 13 is held in the retention spaces 42d of the notches 42 in the arms 41d, 41e, the plate-like member 13 can be pushed down without fail. Then, the plate-like member 13 moves along the grooves 15a, 15b in the direction transverse to the longitudinal direction of the pile main body 12 (in a horizontal direction or an inclined near-horizontal direction) until the plate-like member 13 abuts on the lower terminal ends of the grooves 15a, 15b and stops there. Thereby, the plate-like member 13 is caught and held at transverse portions in the grooves 15a, 15b where the grooves 15a, 15b extend in the direction transverse to the longitudinal direction, i.e. near the lower terminal ends of the grooves 15a, 15b.

Later, as shown in FIG. 20(a), the pile installation jig 41 is pulled out of the ground. For example, to pull out the pile installation jig 41, a hook is engaged in the bores 41h in the pile installation jig 41 and pulled up by construction equipment. As a result, the pile 11 is buried in the ground.

In the state shown in FIGS. 20(a) and 20(b), the plate-like member 13 has moved to the transverse portions where the grooves 15a, 15b extend in the direction transverse to the longitudinal direction of the pile main body 12. Hence, the plate-like member 13 is caught and fixed in the vertical direction of the pile main body 12. Besides, since the surface of the plate-like member 13 lies generally horizontally, the plate-like member 13 is more resistant to vertical displacement caused by sand and dirt and is less likely to move vertically in the ground. Namely, the plate-like member 13 is vertically fixed in the pile main body 12, and sand and dirt prevents vertical displacement of the plate-like member 13. This structure can increase the pullout strength and the supporting capacity of the pile main body 12.

By setting a suitable angle between the surface of the plate-like member 13 and a horizontal plane, a further enhancement of the pullout strength can be expected in the pile main body 12. When the angle is 0 degree, i.e. when the surface of the plate-like member 13 is horizontal, the pullout strength will be greatest. Hence, in any of the embodiments, the surface of the plate-like member 13 is described and illustrated as being substantially horizontal. However, it is not essential to make the surface of the plate-like member 13 horizontal or substantially horizontal. In consideration of the installation depth of the pile main body 12, the geological condition at the installation site, and other conditions, the angle between the surface of the plate-like member 13 and the horizontal plane may be suitably changed along with the length, the width, the thickness, and other requirements of plate-like member 13.

In this context, the term “substantially horizontal” assumes that the angle between the surface of the plate-like member 13 and the horizontal plane is 20 degrees or less. This is suitable for improvement in the pullout strength of the pile main body 12, and is also stable for the installation method in which the plate-like member 13 is subjected to a force from above and thereby caused to move along the grooves 15a, 15b.

Additionally, the pile installation method in the seventh embodiment of the present invention is also applicable when burying the pile 21 in the second embodiment (shown in FIGS. 4, 5, 6(a) and 6(b)) in the ground, with use of the pile installation jig 51 in the fifth embodiment (shown in FIGS. 13, 14(a), 14(b) and 15). This installation method includes the steps shown in FIGS. 21(a)-21(d) and 22.

First, as shown in FIG. 21(a), the walls 51a, 51b and the arms 51d, 51e of the pile installation jig 51 are overlaid on the outside of the walls 22a, 22b of the pile main body 22. Elongated portions including the walls 51a, 51 and the arms 51d, 51e are arranged in the longitudinal direction of the pile main body 22, and the both sides of the plate-like member 23 which project outwardly from the walls 22a, 22b of the pile main body 22 are fitted in the notches 52 in the arms 51d, 51e of the pile installation jig 51. At this stage, the both sides of the plate-like member 23 sit on the receiving edges 52c of the notches 52 in the arms 51d, 51e, so that the plate-like member 23 can be retained in place.

With the pile 21 and the pile installation jig 51 being combined as shown in FIG. 21(a), the pile 21 and the pile installation jig 51 are driven into the ground together as shown in FIG. 21(b).

Referring next to FIGS. 21(c) and 21(d), the pile installation jig 51 is driven deeper into the ground by the length of the grooves 25a, 25b in the pile main body 22. Since the both sides of the plate-like member 23 are fitted in the notches 52 in the arms 51d, 51e of the pile installation jig 51, when the pile installation jig 51 is driven deeper into the ground, the abutment edges 52a of the notches 52 in the arms 51d, 51e of the pile installation jig 51 come into contact with a lateral edge 23c at the both sides of the plate-like member 23, push down the plate-like member 23 from a head 22c side of the pile main body 22, and cause the plate-like member 23 to move along the grooves 25a, 25b downwardly in the longitudinal direction of the pile main body 22. Since the lateral edge 23c at the both sides of the plate-like member 23 is held in the retention spaces 52d of the notches 52 in the arms 51d, 51e, the plate-like member 23 can be pushed down without fail. Further, when the plate-like member 23 moves along the grooves 25a, 25b in the direction transverse to the longitudinal direction of the pile main body 22 (in a horizontal direction or an inclined near-horizontal direction), the points of abutment for the lateral edge 23c of the plate-like member 23 shift from the abutment edges 52a to the inclined edges 52e of the notches 52 in the arms 51d, 51e. Eventually, the inclined edges 52e of the notches 52 cause the lateral edge 23c at the both sides of the plate-like member 23 to move obliquely downward. Thereby, the plate-like member 23 moves smoothly along the grooves 25a, 25b until the plate-like member 23 abuts on the lower terminal ends of the grooves 25a, 25b and stops there.

Later, as shown in FIG. 22, the pile installation jig 51 is pulled out of the ground, and the pile 21 is buried in the ground.

In this case, the plate-like member 23 penetrates the grooves 25a, 25b in pile main body 22, with the bent portions 23b being bent upwardly. At the step of driving the pile main body 22 into the ground, the bent portions 23b of the plate-like member 23 face underground resistance, so that the plate-like member 23 can turn by itself and move smoothly along the J-shaped grooves 25a, 25b.

Further, since the bent portions 23b of the plate-like member 23 project outwardly from the walls 22a, 22b of the pile main body 22, even if the plate-like member 23 is laterally displaced during the step of driving the pile main body 22 into the ground, either one of the bent portions 23b of the plate-like member 23 abuts on one of the walls 22a, 22b of the pile main body 22. Eventually, it is possible to prevent the plate-like member 23 from coming out of the grooves 25a, 25b in the pile main body 22.

At the lower terminal ends of the grooves 25a, 25b in the pile main body 22, the width W of the grooves 25a, 25b is substantially the same or slightly greater than the thickness of the plate-like member 23. Owing to this configuration, when the plate-like member 23 abuts on the lower terminal ends of the grooves 25a, 25b and stops there, the plate-like member 23 is caught without play near the lower terminal ends of the grooves 25a, 25b. Further, the plate-like member 23 is fixed securely by holding sand and dirt on an inner side of the flat central portion 23a and the bent portions 23b. Namely, this arrangement can prevent vertical displacement of the plate-like member 23 relative to the pile main body 22 with more certainty, and can securely fix the plate-like member 23 by sand and dirt. Eventually, this arrangement can further improve the pullout strength and the supporting capacity of the pile main body 22.

The following description concerns a method for installing a pile, as the eighth embodiment of the present invention. The pile installation method in the eighth embodiment of the present invention is a method for burying the pile 31 in the third embodiment (shown in FIGS. 7A, 7B, 8, 9(a) and 9(b)) in the ground, with use of the pile installation jig 61 in the sixth embodiment (shown in FIGS. 16, 17(a), 17(b) and 18). The installation method is carried out by the steps shown in FIGS. 23(a)-23(d) and 24.

First, in the state shown in FIG. 23(a), the plate-like member 33 is inserted through the grooves 35a, 35b in the pile main body 32, with both sides of the plate-like member 33 projecting outwardly from the walls 32a, 32b. In this state, the pile 31 is driven into the ground as shown in FIG. 23(b).

Next, the pile installation jig 61 is driven into the ground as shown in FIG. 23(c). In this step, the walls 61a, 61b of the pile installation jig 61 are overlaid on the outside of the walls 32a, 32b of the pile main body 32 of the pile 31 which has been driven into the ground, and elongated portions including the walls 61a, 61b are arranged in the longitudinal direction of the pile main body 32. In this state, the top panels 61f, 61g of the pile installation jig 61 are repeatedly hit so as to drive the pile installation jig 61 into the ground. Eventually, in the ground, the walls 61a, 61b of the pile installation jig 61 are overlaid on the outside of the walls 32a, 32b of the pile main body 32, and the abutment edges 62a of the walls 61a, 61b of the pile installation jig 61 abut on the lateral edge 33c at the both end portions of the plate-like member 33.

Referring next to FIG. 23(d), the pile installation jig 61 is driven deeper into the ground by the length of the grooves 35a, 35b in the pile main body 32. Since the abutment edges 62a of the walls 61a, 61b of the pile installation jig 61 abut on the lateral edge 33c at the both sides of the plate-like member 33, when pile installation jig 61 is driven deeper into the ground, the abutment edges 62a of the walls 61a, 61b of the pile installation jig 61 push down the plate-like member 33 and cause the plate-like member 33 to descend along the grooves 35a, 35b in the longitudinal direction of the pile main body 32. In this step, since the lateral edge 33c at the both sides of the plate-like member 33 is held in the retention spaces 62d of the notches 62 in the walls 61a, 61b, the plate-like member 33 can be pushed down without fail. Further, when the plate-like member 33 starts to move along the grooves 35a, 35b in the direction transverse to the longitudinal direction of the pile main body 32 (in a horizontal direction or an inclined near-horizontal direction), the points of abutment for the lateral edge 33c of the plate-like member 33 shift from the abutment edges 62a to the inclined edges 62e of the notches 62 in the walls 61a, 61b. Eventually, the inclined edges 62e of the notches 62 push down and cause the lateral edge 33c of the plate-like member 33 to move obliquely downward. Thereby, the plate-like member 33 moves smoothly along the grooves 35a, 35b until the plate-like member 33 abuts on the lower terminal ends of the grooves 35a, 35b and stops there.

Later, as shown in FIG. 24, the pile installation jig 61 is pulled out of the ground, and the pile 31 is buried in the ground.

In this embodiment, the width W of the grooves 35a, 35b is set to be substantially the same or slightly greater than the thickness of the plate-like member 33, from the upper starting ends of the grooves 35a, 35b to starting points of their smooth curves which turn into the direction transverse to the longitudinal direction of the pile main body 22. Owing to this configuration, when the plate-like member 33 is pushed down by the abutment edges 62a of the walls 61a, 61b of the pile installation jig 61, the grooves 35a, 35b can guide the plate-like member 33 downwardly while preventing the plate-like member 33 from wobbling. Besides, while the plate-like member 33 is moving in the ground, it is possible to reduce the underground resistance against the plate-like member 33 and to enable quick displacement of the plate-like member 33 along the grooves 35a, 35b. Moreover, the V-shaped plate-like member 33 projects outwardly in a substantially orthogonal relationship to the walls 32a, 32b of the pile main body 32. The outwardly projecting ends of the plate-like member 33 are long enough to hold a large amount of sand and dirt for securely fixing the plate-like member 33. As a result, the plate-like member 33 serves to improve the pullout strength and the supporting capacity of the pile main body 32 to a greater extent.

The next description concerns other embodiments of the present invention. As shown in FIG. 25 which represents the ninth embodiment of the present invention, a pile 71 has a pile main body 72 in Z-shaped cross section and a plate-like member 73. The pile main body 72 has three walls 72a, 72b, 72c which extend in a longitudinal direction of the pile main body 72. The walls 72a, 72b, 72c are provided with corresponding grooves 72d, 72e, 72f near their leading ends (near a leading end of the pile main body 72). The grooves 72d, 72e, 72f are longitudinally aligned with each other in the pile main body 72, and approximately assume a shape of the letter J, with their curves (the J-shaped curves) oriented in the same direction. The rectangular plate-like member 73 penetrates the grooves 72d, 72e, 72f in a movable manner along the grooves, and both sides of the plate-like member 73 project outwardly from the walls 72a, 72c.

As shown in FIG. 26A which represents the tenth embodiment of the present invention, a pile 81 has a pile main body 82 in H-shaped cross section and a plate-like member 83. The pile main body 82 has two opposed walls 82a, 82b which extend in a longitudinal direction of the pile main body 82. The walls 82a, 82b are provided with corresponding grooves 82c, 82d near their leading ends (near a leading end of the pile main body 82). The grooves 82c, 82d are longitudinally aligned with each other in the pile main body 82, and approximately assume a shape of the letter J, with their curves (the J-shaped curves) oriented in the same direction. The rectangular plate-like member 83 penetrates the grooves 82c, 82d in a movable manner along the grooves, and both sides of the plate-like member 83 project outwardly from the walls 82a, 82b.

In addition to the pair of grooves 82c, 82d, a second pair of grooves 82e, 82f may be formed near the leading ends of the walls 82a, 82b as shown in FIG. 26B, and an additional plate-like member 85 may penetrate the second pair of grooves 82e, 82f in a movable manner along the grooves. Further, another groove 82g may be formed in a central wall which connects the walls 82a, 82b, and another plate-like member 86 may penetrate the additional groove 82g.

As shown in FIG. 27 which represents the eleventh embodiment of the present invention, a pile 91 has a cylindrical pile main body 92 and a plate-like member 93. A circumferential wall of the pile main body 92 is provided with a pair of grooves 92a, 92b near a leading end thereof. The grooves 92a, 92b are longitudinally aligned with each other in the pile main body 92, and approximately assume a shape of the letter J, with their curves (the J-shaped curves) oriented in the same direction. The rectangular plate-like member 93 penetrates the grooves 92a, 92b in a movable manner along the grooves, and both sides of the plate-like member 93 project outwardly from the circumferential wall of the pile main body 92.

A pile installation jig for installing these piles 71, 81, 91 is preferably equipped with two abutment portions which abut on both ends of the plate-like members 73, 83, 93 from a head side of the pile main bodies 72, 82, 92 and which push down the plate-like members 73, 83, 93.

FIGS. 28(a) and 28(b) are a plan view and a sectional view, respectively, showing a first modified example of the plate-like member according to the present invention. A plate-like member 101 in the first modified example is rectangular in plan view, has a wedge-shaped cross section in side view, and has a blade-like shape. The wedge-shaped cross section reduces the resistance against the plate-like member 101 moving under the ground, and facilitates displacement of the plate-like member 101 along the grooves of the pile main body.

FIGS. 29(a) and 29(b) are a plan view and a sectional view, respectively, showing a second modified example of the plate-like member according to the present invention. A plate-like member 102 in the second modified example is rectangular in plan view and has a corrugated cross section in side view. The corrugated cross section increases the bending rigidity of the plate-like member 102, which eventually improves the pullout strength and the supporting capacity of the pile main body. Instead of the corrugated cross section, a serrated cross section is also applicable to obtain similar effects.

FIGS. 30(a) and 30(b) are a plan view and a sectional view, respectively, showing a third modified example of the plate-like member according to the present invention. A plate-like member 104 in the third modified example is equipped with two protrusions 104a at a lateral edge of the plate-like member 104 which abuts on the abutment edges 42a (or the abutment edges 52a or 62a) of the pile installation jig 41 (or the pile installation jig 51 or 61). The arms 41d, 41e (or the arms 51d, 51e, or the walls 61a, 61b) of the pile installation jig 41 (or the pile installation jig 51 or 61) are caught in and between the protrusions 104a. The protrusions 104a can prevent twist or deformation of the arms 41d, 41e (or the arms 51d, 51e, or the walls 61a, 61b) in the ground.

FIGS. 31(a) and 31(b) are a plan view and a sectional view, respectively, showing a fourth modified example of the plate-like member according to the present invention. A plate-like member 105 in the fourth modified example is provided with two recesses 105a at a lateral edge of the plate-like member 105 which abuts on the abutment edges 42a (or the abutment edges 52a or 62a) of the pile installation jig 41 (or the pile installation jig 51 or 61). The arms 41d, 41e (or the arms 51d, 51e, or the walls 61a, 61b) of the pile installation jig 41 (or the pile installation jig 51 or 61) are fitted inside the recesses 105a. The recesses 105a can prevent twist or deformation of the arms 41d, 41e (or the arms 51d, 51e, or the walls 61a, 61b) in the ground.

In the embodiment shown in FIGS. 30(a) and 30(b), the two protrusions 104a provided at the lateral edge of the plate-like member 104 may be replaced by a plurality of protrusions formed on a front or back face of the plate-like member 104, and the arms 41d, 41e (or the arms 51d, 51e, or the walls 61a, 61b) of the pile installation jig 41 (or the pile installation jig 51 or 61) may be caught on an inner side of the protrusions.

Additionally, the piles in the above embodiments and the plate-like members in the above modified examples may be combined or modified as required. For example, regarding the width of each groove in the pile main body, the width at both the upper starting end and the lower terminal end of the groove may be set substantially the same as or slightly greater than the thickness of the plate-like member, and the width at the curve of the groove may be set sufficiently greater than the thickness of the plate-like member. The pile main body may be a quadrangular or cylindrical member, instead of a hollow member, and the quadrangular or cylindrical pile main body may be provided with a single groove through which a plate-like member is arranged to penetrate. Furthermore, after the pile installation jig is employed to move the plate-like member along the groove(s) in the pile main body, the pile installation jig may not be pulled out of the ground but may be left in the ground as a reinforcing member for the pile main body.

Now, turning to the twelfth embodiment of the present invention, description is made of an example of a photovoltaic system using the piles according to the present invention. FIG. 32 is a perspective view of a photovoltaic system in the twelfth embodiment of the present invention. FIG. 33 is a rear view of the photovoltaic system in the twelfth embodiment. FIG. 34 is a side view of this photovoltaic system.

A photovoltaic system 111 is intended to realize, for example, an industrial power plant. The piles 81 in the tenth embodiment as shown in FIG. 26 are employed to fix a rack 113 which holds a multiplicity of photovoltaic modules 112.

In FIGS. 32, 33 and 34, the photovoltaic modules 112 are arranged in the east-west direction and in the north-south direction, and are inclined to face a direction of incidence of the sunlight. The piles 81 are replaceable with the piles in the other embodiments and the modified examples.

In the photovoltaic system of this embodiment as shown in FIGS. 32, 33 and 34, the piles 81 are arranged with a first prescribed gap in the east-west direction and a second prescribed gap in the north-south direction, and driven into the ground as arranged. The rack 113 is fixedly held on upper ends of the piles 81.

The rack 113 includes columns 121 which are provided in a standing manner along extensions of the corresponding piles 81, joint units 122 which connect the columns 121 fixedly on the upper ends of the piles 81, braces 123 which span the columns 121 adjacent in the north-south direction and which serve as reinforcing members, braces 124 which span the columns 121 adjacent in the east-west direction and which serve as reinforcing members, vertical frames 125 which span upper ends of the adjacent north-south columns 121, and four horizontal frames 126 which extend in the east-west direction and which is arranged on and held by the vertical frames 125 aligned in the east-west direction.

In the thus configured rack, a plurality of photovoltaic modules 112 are mounted in a row between the two adjacent horizontal frames 126. As a whole, a plurality of photovoltaic modules 112 are mounted in three rows on the four horizontal frames 126.

FIG. 35 is a perspective view of the joint unit 122 for connecting the column 121 fixedly on the upper end of each pile 81. FIG. 36 is a sectional view of the joint unit 122.

As shown in FIGS. 35 and 36, the joint unit 122 includes an L-shaped attachment 131 and a joint member 134. In use, the L-shaped attachment 131 is mounted on the upper end of the pile 81, with a side wall 131a of the L-shaped attachment 131 being overlaid on either of the two opposed walls 82a, 82b of the pile 81. Then, using two sets of bolts 132 and nuts 133, the side wall 131a of the L-shaped attachment 131 is fixed on the wall 82a or 82b of the pile 81.

Next, the joint member 134 is mounted on a top wall 131b of the L-shaped attachment 131, and fixed thereon with use of a set of a bolt 135, a nut 136, and a spacer 137.

Further, the joint member 134 is inserted into the column 121. A bolt 138 is inserted through holes in the column 121 and in the joint member 134, and a nut is tightly screwed on an end of the bolt 138. In this manner, the column 121 is fixedly connected on the upper end of the pile 81.

Hereinbefore, the preferable embodiments and modified examples of the present invention have been described with reference to the accompanying drawing. However, it goes without saying that the present invention should not be limited by these embodiments and examples. It is apparent that those having ordinary skill in the art can conceive of a variety of alternative examples or modified examples within the scope of the claims, and such examples are naturally understood to be within the technological scope of the present invention.

For example, regarding the pile(s) in the above-mentioned embodiment(s), the pile (the pile 11) is intended to be buried in the ground. The pile has a columnar pile main body (the pile main body 12), at least one groove (the groove 15a), and a plate-like member (the plate-like member 13) inserted through the groove. The groove extends longitudinally downward as seen in the state where the pile main body is buried, and curves in a direction transverse to the longitudinal direction of the pile main body.

In this pile, the pile main body is driven into the ground, with the plate-like member inserted through the groove in the pile main body. In this state, when the plate-like member is pushed down by means of a jig or the like, the plate-like member moves along the groove under the ground. As mentioned above, the groove extends longitudinally downward as seen in the state where the pile main body is buried, and curves in the direction transverse to the longitudinal direction of the pile main body. Hence, the plate-like member moving along the groove is caught and held at a transverse portion where the groove extends in the direction transverse to the longitudinal direction. In this state, displacement of the plate-like member in a pullout direction (a longitudinally upward direction) of the pile main body is inhibited by the transverse portion where the groove extends in the direction transverse to the longitudinal direction of the pile main body, and the plate-like member is fixed by sand and dirt. Eventually, it is possible to improve the pullout strength and the supporting capacity of the pile main body.

Regarding the pile(s) of the above-mentioned embodiment(s), the groove is composed of a plurality of grooves. Such grooves (the grooves 15a, 15b) formed in the pile main body are longitudinally aligned, with their curves oriented in the same direction.

In the pile(s) of the above-mentioned embodiment(s), the groove is composed of a plurality of grooves. Suppose that there is a virtual symmetrical plane which passes between the grooves and which extends in the longitudinal direction of the pile main body, the grooves are formed in plane symmetry about the virtual symmetrical plane.

In this case, the pile main body is driven into the ground, with the plate-like member penetrating the plurality of grooves in the pile main body. When the plate-like member is pushed down, the plate-like member moves along the grooves until the plate-like member is caught and held at transverse portions where the grooves extend in the direction transverse to the longitudinal direction of the grooves. Since more than one part of the plate-like member is caught and held in the grooves, the plate-like member is held more securely, and the pullout strength and the supporting capacity of the pile main body can be improved to a greater extent.

Further, in the pile(s) of the above-mentioned embodiment(s), the pile main body has a plurality of walls (the walls 12a, 12b) which extend in the longitudinal direction of the pile main body. The grooves are formed in the corresponding walls.

For example, the pile main body made of an L-shaped steel has two walls, whereas the pile main body made of an H-shaped steel has three walls. Each of these walls is provided with a groove.

Furthermore, in the pile(s) of the above-mentioned embodiment(s), the width of each groove varies from one part of the groove to the other.

For example, in the case where the width of each groove is reduced at the transverse portion where the groove extends in the direction transverse to the longitudinal direction of the pile main body, the plate-like member moving along the groove is caught at this narrowed portion without play. This arrangement further improves the supporting capacity of the pile main body.

Still further, in the pile(s) of the above-mentioned embodiment(s), the plate-like member has a wedge-shaped cross section.

The wedge-shaped cross section in the plate-like member serves to reduce the resistance against the plate-like member moving under the ground and to facilitate displacement of the plate-like member along the groove(s).

Turning next to the pile installation jig(s) in the above-mentioned embodiment(s), the pile installation jig (the pile installation jig 41) is employed to install a pile. The pile installation jig has elongated portions (the walls 41a, 41b and the arms 41d, 41e) and abutment portions (abutment edges 42a). The elongated portions are arranged in the longitudinal direction of the pile main body of the pile to be installed. When a longitudinally downward force is applied on the top of the pile installation jig, the abutment portions can abut on a member projecting from the pile main body and can push the projecting member in an inclined direction relative to the longitudinal direction of the pile main body.

In this pile installation jig, the abutment portions abut, from above as seen in the state where the pile main body is buried, on the member projecting from the pile main body. When the pile installation jig is hit deeper into the ground, the abutment portions push down the projecting member.

Regarding the pile installation jig(s) in the above-mentioned embodiment(s), the abutment portions are provided with inclined portions (the inclined edges 52e) which are continuous from the abutment portions. As the inclined portions extend toward the top of the pile main body as seen in the state where the pile main body is buried, the inclined portions are designed to be more distant from the abutment portions in the direction transverse to the longitudinal direction of the pile installation jig. In this case, the projecting member is first pushed down by the abutment portions, and then pushed down obliquely by the inclined portions.

Further regarding the pile installation jig(s) in the above-mentioned embodiment(s), the pile installation jig is equipped with receiving portions (the receiving edges 42c) which are opposed to the abutment portions over the projecting member and which receive the projecting member. In this case, the projecting member is held between the abutment portions and the receiving portions.

Turning next to the pile installation methods in the above-mentioned embodiments, one of the methods includes the step of driving a pile main body into the ground, and the step of driving a pile installation jig into the ground and causing displacement of a plate-like member inserted in at least one groove, wherein the at least one groove extends longitudinally downward as seen in a state where the pile main body is buried, and curves in the direction transverse to the longitudinal direction of the pile main body.

In this pile installation method, the pile main body is driven into the ground first, and the pile installation jig is driven into the ground later, whereby the pile installation jig pushes down the plate-like member and causes displacement of the plate-like member along the grooves.

An alternative pile installation method in the above-mentioned embodiment includes the step of driving a pile main body and a pile installation jig together into the ground, and the step of driving the pile installation jig deeper into the ground than an installation position of the pile main body and causing displacement of a plate-like member inserted in at least one groove, wherein the at least one groove extends longitudinally downward as seen in a state where the pile main body is buried, and curves in the direction transverse to the longitudinal direction of the pile main body.

In this pile installation method, the pile main body and the pile installation jig are driven into the ground at the same time, and the pile installation jig is driven deeper into the ground later, whereby the pile installation jig pushes down the plate-like member and causes displacement of the plate-like member along the groove(s).

The pile installation methods in the above-mentioned embodiments further include the step of pulling the installation jig out of the ground.

The photovoltaic system in the above-mentioned embodiment includes a plurality of piles, a rack assembled on the piles, a plurality of photovoltaic modules held on the rack. Each of the piles has a columnar pile main body, at least one groove formed in the pile main body, which extend(s) longitudinally downward as seen in a state where the pile main body is buried and which curve(s) in the direction transverse to the longitudinal direction of the pile main body, and a plate-like member inserted through the groove(s).

This photovoltaic system also exhibits the operations and effects similar to those achieved in the above embodiments.

### DESCRIPTION OF THE REFERENCE NUMERALS

11, 21, 31, 71, 81, 91 piles
12, 22, 32, 72, 82, 92 pile main bodies
13, 23, 33, 73, 83, 93, 101, 102 plate-like members
15a, 15b, 25a, 25b, 35a, 35b grooves
41, 51, 61 pile installation jigs
41a, 41b, 51a, 51b, 61a, 61b walls (elongated portions)
41d, 41e, 51d, 51e arms (elongated portions)
42, 52, 62 notches
52e, 62e inclined edges (inclined portions)
42a, 52a, 62a abutment edges (abutment portions)
42c, 52c, 62c receiving edges (receiving portions)
111 photovoltaic system
112 photovoltaic modules
113 rack
121 columns
122 joint units
123, 124 braces
125 vertical frames
126 horizontal frames

1-5. (canceled)

6. A pile to be buried in the ground, comprising:
a pile main body composed of a columnar member and including a plurality of grooves which extend in a longitudinal direction of the columnar member and which curve in a direction transverse to the longitudinal direction; and
a plate-like member which penetrates the grooves,
wherein
suppose that there is a virtual symmetrical plane which passes between the grooves and which extends in a longitudinal direction of the pile main body, the grooves are formed in plane symmetry about the virtual symmetrical plane, and
the plate-like member penetrates the grooves in a movable manner along the grooves, with orientation of a surface of the plate-like member being changed from along the longitudinal direction of the pile main body to along a direction transverse to the longitudinal direction.

7. The pile according to claim 6, wherein the grooves are formed such that an angle between the surface of the plate-like member and a horizontal plane is 20 degrees or less in a state where the pile is buried in the ground.

8. A pile installation jig which can be employed to install the pile according to claim 6, comprising:
an elongated portion arranged in the longitudinal direction of the pile main body; and
an abutment portion provided closer to an end of the elongated portion than to a center thereof and configured to push the plate-like member.

9. A method for installing a pile, comprising the steps of:
driving a pile into the ground,
the pile including a pile main body and a plate-like member, the pile main body being composed of a columnar member and including at least one groove which extends in a longitudinal direction of the columnar member and which curves in a direction transverse to the longitudinal direction, and the plate-like member penetrating the groove; and
driving a pile installation jig into the ground to cause displacement of the plate-like member along the groove.

10. A method for installing a pile, comprising the steps of:
driving a pile and a pile installation jig together into the ground,
the pile including a pile main body and a plate-like member, the pile main body being composed of a columnar member and including at least one groove which extends in a longitudinal direction of the columnar member and which curves in a direction transverse to the longitudinal direction, and the plate-like member penetrating the groove; and
driving the pile installation jig further into the ground to cause displacement of the plate-like member along the groove.

11. A photovoltaic system comprising:
a rack assembled on a plurality of piles according to claim 6 and
a photovoltaic module held on the rack.
